(19) United States
(12) Patent Application Publication
(10) Pub. No.: US 2025/0180952 A1
(43) Pub. Date: Jun. 5, 2025

(54) PHOTOALIGNING MATERIALS

(71) Applicant: ROLIC TECHNOLOGIES AG, Allschwil (CH)

(72) Inventors: Frederic LINCKER, Allschwil (CH); Jean-François ECKERT, Allschwil (CH); Rony BECHARA, Allschwil (CH); Qian TANG, Allschwil (CH)

(73) Assignee: ROLIC TECHNOLOGIES AG, Allschwil (CH)

(21) Appl. No.: 18/842,109

(22) PCT Filed: Mar. 8, 2023
(86) PCT No.: PCT/EP2023/055888

§ 371 Date: Aug. 28, 2024

(30) Foreign Application Priority Data
Mar. 16, 2022 (EP) 22162400.0

(51) Int. Cl. G02F 1/1337; C09K 19/38

(52) U.S. Cl. CPC G02F 1/133723; C09K 19/3895; G02F 1/133788

(57) ABSTRACT

The present invention relates to a photoaligning compound of formula (I), to a process for the preparation of this compound, to a photoaligning composition, obtained by this process, to the use of said compositions as orienting layer for liquid crystals and in the construction of unstructured and structured optical elements and multi-layer systems, especially liquid crystal displays.

The present invention relates to a photoaligning compound of formula (I), to a process for the preparation of this compound, to a photoaligning composition, obtained by this process, to the use of said compositions as orienting layer for liquid crystals and in the construction of unstructured and structured optical elements and multi-layer systems, especially liquid crystal displays. There is an ever-growing demand to develop new photo-aligning materials for optical and electro-optical applications. Nowadays there is an increasing demand for green technology for the consumer and in large scale manufacturing processes. Especially, in display industries there is a constant need to increase the production efficiency by reduction of power consumption and time durations during different process steps. The consumer on the other hand prefers to watch large size higher definition televisions, which consume generally high energy. One way to decrease energy consuming is to decrease the intensity needed by the backlight. It is described by Y. Yamada, Q. Tang, M. Koechlin and Y. Yamaoto in Late-News Paper, SID 2017 DIGEST, pages 708 to 711, that an efficient use of backlight requires high transmittance.

In the present invention new photoaligning material was found which gives access to an economic manufacturing process and low energy consuming LCDs without decreasing the required technical properties. Accordingly, in the present invention a compound of formula (I), preferably a photoaligning copolymer, was found:

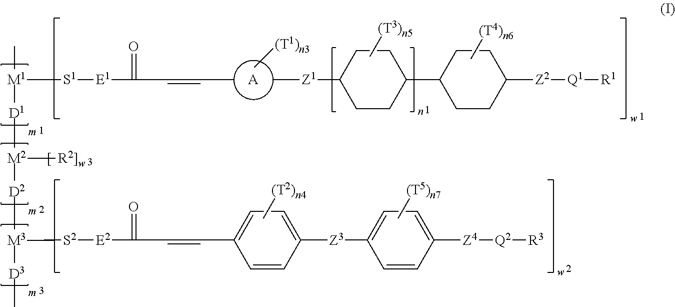

wherein,
M¹, M² and M³ represent independently from each other an unsubstituted or substituted carbocyclic or heterocyclic aromatic or non-aromatic diamine group selected from a monocyclic ring of five or six atoms; two adjacent monocyclic rings of five or six atoms, a bicyclic ring system of eight, nine or ten atoms, a tricyclic ring system of thirteen or fourteen atoms, and mono-, bi-, tricyclic rings, which are linked by a straight-chain or branched, substituted or unsubstituted C₁-C₂₀alkanediyl, which is unsubstituted or substituted by di-(C₁-C₂₀alkyl)amino, C₁-C₆alkyloxy, nitro, cyano and/or chlorine or fluorine; and wherein one or more C—, CH—, CH₂— group may independently be replaced by a linking group;
D¹, D² and D³ represent independently from each other an unsubstituted or substituted aliphatic, alicyclic group or carbocyclic or heterocyclic aromatic group substituted with at least two carboxylic acid groups, or activated carboxylic groups, or anhydride groups;
m¹, m² or m³ represent independently from each other molar fractions of the comonomers with 0<m¹<1, 0≤m²≤0, 7 and 0≤m³<1; preferably 0<m¹<1, 0≤m²≤0.5 and 0≤m³<1,
S¹ and S² represent independently from each other a spacer unit,
E¹ and E² represent independently from each other an aromatic group, an oxygen atom, a sulphur atom, —NH—, —N(C₁-C₆alkyl)-, —CR⁴R⁵, wherein R⁴ and R⁵ are independently from each other hydrogen or a cyclic, straight-chain or branched, substituted or unsubstituted C₁-C₃₀alkyl, wherein one or more C—, CH—, CH₂— group may be independently from each other replaced by a linking group, and with the proviso that at least one of R⁴ and R⁵ is not hydrogen;
A represents an unsubstituted or substituted carbocyclic or heterocyclic aromatic group, preferably A is an unsubstituted or substituted phenylene, naphthalene, biphenylene or triphenylene, and more preferably, A is an unsubstituted or substituted phenylene,
Z¹, Z², Z³ and Z⁴ represent independently from each other a bridging group, which is preferably selected from —(CO)—, —(CO)O—, —O(CO)—, —O(CO)O—, —O—, —(CO)NH— or a single bond,
Q¹ and Q² represent independently from each other a single bond, or a straight-chain or branched, substituted or unsubstituted C₁-C₂₀alkanediyl, which is unsubstituted or substituted by di-(C₁-C₂₀alkyl)amino, C₁-C₆alkyloxy, nitro, cyano and/or chlorine or fluorine; and wherein one or more C—, CH—, CH₂— group may independently be replaced by a linking group;
R² represents hydrogen or a straight-chain or branched C₁-C₂₀alkyl, which is unsubstituted or substituted by di-(C¹-C₂₀alkyl)amino, C₁-C₆alkyloxy, nitro, cyano and/or chlorine or fluorine; and wherein one or more C—, CH—, CH₂— group may independently be replaced by a linking group, preferably R² represents hydrogen, methyl or trifluoromethyl;
R¹ and R³ represent independently from each other hydrogen or C_{c}H_{α}F_{β}p, wherein c is an integer of 0 to 20, and a and p are integers of 0 to 2 c+1, respectively, wherein a+p=2 c+1;
T¹, T², T³, T⁴ and T⁵ represent independently from each other hydrogen, halogen, hydroxyl, nitro, cyano or a carboxy group, and/or a cyclic, straight-chain or branched C₁-C₃₀alkyl, which is unsubstituted, mono- or poly-substituted with halogen, acryloyloxy, alkylacryloyloxy, alkoxy, alkylcarbonyloxy, alkyloxycarbonyl-oxy, alkyloxocarbonyloxy, vinyl, vinyloxy and/or allyloxy group, wherein the alkyl residue has preferably from 1 to 20 carbon atoms, and more preferably having from 1 to 10 carbon atoms; preferred substitutents of the alkyl residue are hydrogen, methyl, trifluoromethyl, fluorine and/or chlorine, wherein one or more, preferably non-adjacent, C—, CH—, CH₂— group may independently of each other be replaced by a linking group; preferably, the linking group is selected from —O—, —(CO)—, —(CO)O— and —O(CO)—; more preferably, T¹, T², T³, T⁴ and T⁵ represent hydrogen, methyl, trifluoromethyl, or an alkyl residue, wherein one or more, preferably non-adjacent, C—, CH—, CH₂— group may independently of each other be replaced by a linking group; preferably, the linking group is selected from —O—, —(CO)—, —(CO)O— and/or —O(CO)—;
   n¹ is 0, 1 or 2 and preferably 0 or 1, and more preferably 1,
n³, n⁴, n⁵, n⁶ and n⁷ represent independently from each other 0, 1, 2 or 3; preferably, n³, n⁴, n⁵, n⁶ and n⁷ represent 0 or 1; more preferably n⁴, n⁵, n⁶ and n⁷ are 0 and n³ is 0 or 1;
w³ represents 0, 1, 2, 3 or 4; preferably, 0, 1 or 2;
w¹ and w² represent independently from each other is 0, 1, 2, 3 or 4, with the proviso that if w¹ or w² is 2, 3, or 4, each S¹ and S², E¹ and E², Z¹, Z², Z³ and Z⁴, Q¹ and Q², R², R¹ and R³, T¹, T², T³, T⁴ and T⁵, n¹, n³, n⁴, n⁵, n⁶ and n⁷ may be identical or different, preferably identical;
and preferably compound of formula (I), wherein preferably, if w¹ or w² or w³ are >1, then the side chain of formula (I) are linked to one single atom, preferably a carbon atom, within group M¹, M² or/and M³, or
they are linked to different atomic positions within group M¹, M² or/and M³, or
they are linked to adjacent atomic positions within group M¹, M² or/and M³, or/and they can linked spaced further apart.

It is understood in the context of the present invention that if m² is 0, there is also no side chain at M², and if m³ is 0, there is also no side chain at M³.

The term “linking group”, as used in the context of the present invention is preferably be selected from a single bond, —O—, —CO, —(CO)—, —O(CO)—,

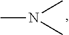

—NR^{1′}—, —NR^{1′}—CO—, —CO—NR^{1′}—, —NR¹—(CO)O—, —O(CO)—NR^{1′}—, —NR^{1′}—CO—NR^{1′}—, —CH═CH—, —C≡C—, —O—CO—O—, and —Si(CH₃)₂—O—Si(CH₃)₂—, and wherein:
R^{1′} represents a hydrogen atom or C₁-C₆alkyl;
with the proviso that oxygen atoms of linking groups are not directly linked to each other.

The term “spacer unit” as used in the context of the present invention, is preferably a single bond, a cyclic, straight-chain or branched, substituted or unsubstituted C₁-C₂₀alkanediyl nt, C—, CH—, CH₂— group may independently from each other be replaced by a linking group as described above and/or a non-aromatic, aromatic, unsubstituted or substituted carbocyclic or heterocyclic group connected via bridging groups.

More preferably, the spacer unit is a cyclic, straight-chain or branched, substituted or unsubstituted C₁-C₂₀alkanediyl, wherein one or more, preferably non-adjacent, C—, CH—, CH₂— group may independently from each other be replaced by a linking group and/or a non-aromatic, aromatic, unsubstituted or substituted carbocyclic or heterocyclic group connected via bridging groups.

A bridging group as used in the context of the present invention is selected from —CH(OH)—, —CO—, —CH₂(CO)—, —SO—, —CH₂(SO)—, —SO₂—, —CH₂(SO₂)—, —O—, —(CO)O—, —O(CO)—, —O(CO)O—, —COCF₂—, —CF₂CO, —S—CO—, —CO—S—, —SOO—, —OSO—, —SOS—, —CH₂—CH₂—, —OCH₂—, —CH₂O—, —CH═CH—, —C≡C—, —CH═CH—(CO)O—, —OCO—CH═CH—, —CH═N—, —C(CH₃)=N—, —N═N— or a single bond; or a cyclic, straight-chain or branched, substituted or unsubstituted C₁-C₂₀alkanediyl, wherein one or more C—, CH—, CH₂ groups may independently from each other be replaced by a linking group as described above.

Preferably, a briding group is selected from —O—, —(CO)O—, —O(CO)—, or a single bond.

Alkyl, alkyloxy, alkylcarbonyloxy, acryloyloxyalkoxy, acryloyloxyalkyl, acryloyloxyalken, alkyloxycarbonyloxy, alkylacryloyloxy, methacryloyloxyalkoxy, methacryloyloxyalkyl, methacryloyloxyalken, alkylmethacryloyloxy, alkylmethacryloyloxy, alkylvinyl, alkylvinyloxy and alkylallyloxy and alkanediyl, as used in the context of the present invention denote with their alkyl residue; respectively their alkanediyl residue; a cyclic, straight-chain or branched, substituted or unsubstituted alkyl, respectively alkanediyl in which one or more, preferably non-adjacent, C—, CH—, CH₂— group may be replaced by a linking group.

Further, the alkyl residue is for example C₁-C₄₀alkyl, especially C₁-C₃₀alkyl, preferably C₁-C₂₀alkyl, more preferably C₁-C₁₆alkyl, most preferably C₁-C₁₀alkyl and especially most preferably C₁-C₆alkyl. Accordingly, alkanediyl is for example C₁-C₄₀-, especially C₁-C₃₀-, preferably C₁-C₂₀-, more preferably C₁-C₁₆-, most preferably C₁-C₁₀- and especially most preferably C₁-C₆alkanediyl.

In the context of the present invention the definitions for alkyl given below, are applicable in analogy to alkanediyl, to oxy ether of alkyl derivatives such as acryloyloxyalkanediyl, acryloyloxyalkoxy, such as preferably methacryloyloxyalkoxy.

C₁-C₆alkyl is for example methyl, ethyl, propyl, isopropyl, butyl, sec.-butyl, tert.-butyl, pentyl or hexyl. C₁-C₁₀alkyl is for example methyl, ethyl, propyl, isopropyl, butyl, sec.-butyl, tert.-butyl, pentyl, hexyl, heptyl, octyl, nonyl, decyl.

C₁-C₁₆alkyl is for example methyl, ethyl, propyl, isopropyl, butyl, sec.-butyl, tert.-butyl, pentyl, hexyl, heptyl, octyl, nonyl, decyl, undecyl, dodecyl, tridecyl, tetradecyl, pentadecyl or hexadecyl.

C₁-C₂₀alkyl is for example methyl, ethyl, propyl, isopropyl, butyl, sec.-butyl, tert.-butyl, pentyl, hexyl, heptyl, octyl, nonyl, decyl, undecyl, dodecyl, tridecyl, tetradecyl, pentadecyl, hexadecyl, heptadecyl, octadecyl, nondecyl, eicosyl.

An aliphatic group is for example a saturated or unsaturated, mono-, bi-, tri-, tetra-, penta-, hexa-, hepta-, octa-, nona-, deca-valent alkyl, alkanediyl, alkyloxy, alkylcarbonyloxy, acryloyloxy, alkylacryl, alkylmethacryl, alkyl(en)acryl(en), alkyl(en)methacryl(en), alkyloxycarbonyloxy, alkyloxycarbonyloxy methacryloyloxy, alkylvinyl, alkylvinyloxy or alkylallyloxy, which may comprise one or more heteroatom and/or bridging group.

An alicyclic group is a non-aromatic group or unit. Preferably an alicyclic group is a non-aromatic carbocyclic or heterocyclic group and represents for example ring systems, with 3 to 30 carbon atoms, as for example cyclopropane, cyclobutane, cyclopentane, cyclopentene, cyclohexane, cyclohexene, cyclohexadiene, bicylcohexylene, decaline, tetrahydrofuran, dioxane, pyrrolidine, piperidine or a steroidal skeleton such as cholesterol.

The term “aromatic” group, follows Hückel's rule (for rings: when the number of its π electrons equals 4n+2, wherein n is an integer natural number, e.g. 0, 1, 2, 3, etc) as used in the context of the present invention, and preferably denotes unsubstituted or substituted carbocyclic and heterocyclic groups, incorporating five, six, ten ot 14 ring atoms, e.g. furan, phenylene, pyridine, pyrimidine, naphthalene, which may form ring assemblies, such as biphenylene or triphenylen, which are uninterrupted or interrupted by at least a single heteroatom and/or at least a single bridging group; or fused polycyclic systems, such as phenanthrene, tetraline. Preferably, aromatic group are phenylene, naphthalene, biphenylene or triphenylene groups. More preferred aromatic groups are phenylene, naphthalene, and biphenylene groups.

A carbocyclic or heterocyclic aromatic or non-aromatic group, preferably carbocyclic or heterocyclic aromatic or non-aromatic diamine group, incorporates preferably, three, four, five, six, ten or 14 ring atoms, as for example furan, pyrazol, imidazole, oxazole, thiazole und thiazine, pyridine, piperidine, triazine, pyrimidine, chinolin, isochinoline, indol, purine, benzimidazole, naphthalene, phenanthrene, biphenylene or tetraline units, preferably naphthalene, phenanthrene, biphenylene or phenylene, more preferably naphthalene, biphenylene or phenylene, and most preferably phenylene. The carbocyclic or heterocyclic aromatic or non-aromatic group, preferably carbocyclic or heterocyclic aromatic or non-aromatic diamine group, is for example unsubstituted or mono- or poly-substituted. Preferred substitutents are at least one halogen, hydroxyl, a polar group, alkyl, a carboxylic acid, an acyl group, such as acid chloride, ester groups, carbonates, such as tert-butyl carbonates; an anhydride; trifluoroalkyl, acryloyloxy, alkylacryloyloxy, alkoxy, alkylcarbonyloxy, alkyloxycarbonyloxy, alkyloxocarbonyloxy, methacryloyloxy, vinyl, vinyloxy and/or allyloxy group, wherein the alkyl residue has preferably from 1 to 20 carbon atoms, and more preferably, having from 1 to 10 carbon atoms. Preferred polar groups are nitro, cyano or a carboxy group, and/or a cyclic, straight-chain or branched C₁-C₃₀alkyl, which is unsubstituted, mono- or poly-substituted. Preferred substitutents of C₁-C₃₀alkyl are methyl, fluorine and/or chlorine, wherein one or more, preferably non-adjacent, C—, CH—, CH₂— group may independently of each other be replaced by a linking group. Preferably, the linking group is selected from —O—, —CO—, —(CO)O— and/or —O(CO)—.

A monocyclic ring of five or six atoms is for example unsubstituted or substituted furan, phenylene, pyridine, pyrimidine, preferably phenylene, pyridine, pyrimidine.

A bicyclic ring system of eight, nine or ten atoms is for example unsubstituted or substituted naphthalene, biphenylene, benzimidazole or tetraline.

A tricyclic ring system of thirteen or fourteen atoms is for example unsubstituted or substituted phenanthrene.

The term “phenylene”, as used in the context of the present invention, preferably denotes a unsubstituted or substituted 1,2-, 1,3- or 1,4-phenylene group, which is optionally substituted. It is preferred that the phenylene group is either a 1,3- or a 1,4-phenylene group. 1,4-phenylene groups are especially preferred.

The term “halogen” denotes a chloro, fluoro, bromo or iodo substituent, preferably a chloro or fluoro substituent, more preferably fluoro.

The term “polar group”, as used in the context of the present invention primarily denotes a group like a nitro, cyano, or a carboxy group.

The term “heteroatom”, as used in the context of the present invention primarily denotes oxygen, sulphur, and nitrogen, preferably oxygen and nitrogen, in the latter case preferably in the form of oxygen or —NH—.

The wording “optionally substituted” as used in the context of the present invention primarily means substituted by lower alkyl, such as C₁-C₆alkyl, lower alkoxy, such as C₁-C₆alkoxy, trifluoro-C₁-C₆alkyl, hydroxy, halogen, preferably fluoro, or by a polar group as defined above.

The term “diamine group” is to be understood as designating a chemical structure which has at least two amino groups, i.e., which may also have 3 or more amino groups. The at least two amino groups are preferably able to react with e.g., two carboxylic acid groups, or activated carboxylic groups, or anhydride groups; as outlined in more detail below.

The term “dinitro” or “dinitro compound” is to be understood as designating a chemical structure which has at least two nitro groups, i.e., which may also have 3 or more nitro groups, and wherein the dinitro group is a precursor compound of the “diamino compound”. The dinitro compound is conventionally converted to the diamino compound by reduction methods known in the art.

With respect to straight chain or branched alkyl, alkane group alkoxy, alkylcarbonyloxy, acryloyloxyalkoxy, acryloyloxyalkyl, acryloyloxyalkene, alkyloxycarbonyloxy, alkylacryloyloxy, methacryloyloxyalkoxy, methacryloyloxyalkyl, methacryloyloxyalkene, alkylmethacryloyloxy, alkylmethacryloyloxy, alkylvinyl, alkylvinyloxy, alkylallyloxy and alkanediyl groups it is repeatedly pointed out that some or several of the C—, CH—, CH₂— group may be replaced e.g. by heteroatoms, but also by other groups, preferably bridging groups. In such cases it is generally preferred that such replacement groups are not directly linked to each other. It is alternatively preferred that heteroatoms, and in particular oxygen atoms are not directly linked to each other.

Preferably, M¹, M² and M³ are independently from each other selected from formula (III):

H(R^{6′})N-(Sp¹)ₖ₁-(X¹)ₜ₁—(Z⁵—C³)ₐ₃—(Z⁶—C⁴)ₐ₄—(X²)ₜ₂-(Sp²)ₖ₂-N(R⁶)H (III)
wherein:
R⁶, R^{6′} each independently from each other represent a hydrogen or
C₁-C₆alkyl; preferably they represent hydrogen,
Sp¹, Sp² each independently from each other represent a single bond, an unsubstituted or substituted straight-chain or branched C₁-C₂₀alkanediyl, in which one or more C—, CH—, CH₂— group may independently from each other be replaced by a linking group, and
k¹, k² each independently is an integer having a value of 0 or 1; and
X¹, X² each independently represents a linking spacer, preferably selected from —O—, —S—, —NH—, N(CH₃)—, —CH(OH)—, —CO—, —CH₂(CO)—, —SO—, —CH₂(SO)—, —SO₂—, —CH₂(SO₂)—, —(CO)O—, —O(CO)—, —O(CO)—O—, —S—CO—, —CO—S—, —SOO—, —OSO—, —SOS—, —CH₂—CH₂—, —OCH₂—, —CH₂O—, —CH═CH—, or —C≡C— or a single bond; preferably they are a single bond; and
t¹, t² each independently is an integer having a value of 0 or 1; and
C₃, C₄ each independently represents a non-aromatic, aromatic, substituted or unsubstituted carbocyclic or heterocyclic group, which may have a side chain T;
   preferably C₃, C₄ are a substituted or unsubstituted phenylene, biphenylene or benzimidazole, wherein the substituents are methyl or trifluoromethyl, and
Z⁵ represents a bridging group; preferably represents a single bond, and
Z⁶ represents a single bond, or a substituted or unsubstituted straight-chain or branched C₁-C₂₀alkanediyl group, in which one or more C—, CH—, CH₂— group may independently from each other be replaced
   by a non-aromatic, aromatic, unsubstituted or substituted carbocyclic or heterocyclic group; and/or
   by a heteroatom, preferably oxygen; and/or
   by a bridging group as described above; preferably, Z⁶ has one of the meanings of Z⁵ or represents an unsubstituted or substituted straight-chain or branched C₁-C₁₄alkanediyl group, in which one or more, preferably non-adjacent, C—, CH—, CH₂— group may be replaced by an oxygen atom and/or one or more carbon-carbon single bond is replaced by a carbon-carbon double or a carbon-carbon triple bond; preferably Z⁶ is oxygen or a single bond; and preferably
M¹ and M³ in formula (I) are independently from each other are at least once linked to at least one group S¹ via group Sp¹ and/or Sp²; and/or linked via at least one non-aromatic, aromatic, substituted or unsubstituted carbocyclic or heterocyclic group of C₃ and/or of group C₄, and/or linked via at least one side chain T of group C₄ and/or of group C₃; and/or linked via group Z⁶; and at least one of k¹, k², a³ and a⁴ is not equal to zero; and wherein linking group and bridging group are as described above;
M² in formula (I) w is at least once linked to at least one group R² via group Sp¹ and/or Sp²; and/or linked via at least one non-aromatic, aromatic, substituted or unsubstituted carbocyclic or heterocyclic group of C₃ and/or of group C₄, and/or linked via at least one side chain T of group C₄ and/or of group C₃; and/or linked via group Z⁶; and at least one of k¹, k², a³ and a⁴ is not equal to zero; and wherein linking group and bridging group are as described above.

The wording “side chain”, T, represents a substituted or unsubstituted straight-chain or branched C₁-C₂₀alkanediyl group(s), in which one or more C—, CH—, CH₂— group may independently from each other be replaced by a non-aromatic, aromatic, unsubstituted or substituted carbocyclic or heterocyclic group, or a heteroatom and/or by a bridging group, which is at least once linked to at least one group S¹ or S² in formula (I).

More preferably, M¹, M² and M³ are independently from each other selected from formula (III), wherein:
C₃, C₄ independently from each other are selected from a compound of group G², wherein group G² denotes:

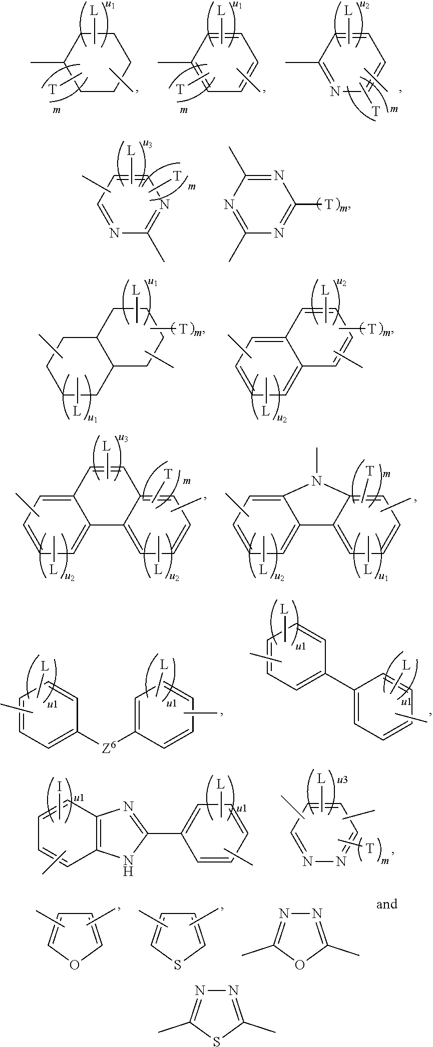

wherein
“______” denotes the connecting bonds of C³ and C⁴ to the adjacent groups of compounds of formula (III) as described above; and
L is C₁-C₆alkyl, especially —CH₃; C₁-C₆alkylfluoro, especially —CF₃; —COCH₃, —OCH₃, nitro, cyano, halogen, CH₂═CH—, CH₂=C(CH₃)—, CH₂═CH—(CO)O—, CH₂═CH—O—, —NR^{6′}R⁶, CH₂═C(CH₃)—(CO)O—, CH₂═C(CH₃)—O—, wherein: R^{6′}, R⁶ each independently from each other represents a hydrogen atom or C₁-C₆alkyl;
T represents a substituted or unsubstituted straight-chain or branched C₁-C₂₀alkanediyl group, in which one or more —CH₂— group may independently from each other be replaced by a non-aromatic, aromatic, unsubstituted or substituted carbocyclic or heterocyclic group, or a heteroatom and/or by a bridging group;
m is an integer from 0 to 2; preferably 1 or 0; and more preferably 0;
Z⁶ represents a single bond, or a substituted or unsubstituted straight-chain or branched C₁-C₂₀alkanediyl group, in which one or more C—, CH—, CH₂— group may independently from each other be replaced by a non-aromatic, aromatic, unsubstituted or substituted carbocyclic or heterocyclic group; and/or a heteroatom and/or by a bridging group as described above; preferably, Z⁶ represents an unsubstituted or substituted straight-chain or branched C₁-C₁₄alkanediyl group, in which one or more, preferably non-adjacent, C—, CH—, CH₂— group may be replaced by an oxygen atom and/or one or more carbon-carbon single bond is replaced by a carbon-carbon double or a carbon-carbon triple bond; preferably Z⁶ is oxygen or a single bond; and
u₁ is an integer from 0 to 4, with the proviso that m+u₁ is ≤4; and
u₂ is an integer from 0 to 3; with the proviso that m+u₂ is ≤3; and
u₃ is an integer from 0 to 2; with the proviso that m+u₃ is ≤2.

Further more preferred M¹, M² and M³ are independently from each other more preferably selected from the following group of structures: substituted or unsubstituted o-phenylenediamine, p-phenylenediamine, m-phenylenediamine, biphenyldiamine, 4-[4-amino-2-(trifluoromethyl)phenyl]-3-(trifluoromethyl)aniline, aminophenylen-Z⁶-phenylenamino, wherein Z⁶ has the same meaning and preferences as given above for Z⁶ in compound of formula (III), and is especially oxygen; naphthylenediamine, benzidine, diaminofluorene, 3,4-diaminobenzoic acid, 3,4-diaminobenzyl alcohol dihydrochloride, 2,4-diaminobenzoic acid, L-(+)-threo-2-amino-1-(4-aminophenyl)-1,3-propanediol, p-aminobenzoic acid, [3,5-3h]-4-amino-2-methoxybenzoic acid, L-(+)-threo-2-(N,N-dimethylamino)-1-(4-aminophenyl)-1,3-propanediol, 2,7-diaminofluorene, 4,4′-diaminooctafluorobiphenyl, 3,3′-diaminobenzidine, 2,7-diamino-9-fluorenone, 3,5,3′,5′-tetrabromo-biphenyl-4,4′-diamine, 2,2′-dichloro[1,1′-biphenyl]-4,4′-diamine, 3,9-diamino-1,11-dimethyl-5,7-dihydro-dibenzo(a,c)cyclohepten-6-one, dibenzo(1,2)dithiine-3,8-diamine, 3,3′-diaminobenzophenone, 3,3′-diaminodiphenylmethane, 4-(4-amino-2-methyl-phenyl)-3-methyl-aniline, 2-(trifluoromethyl)benzene-1,3-diamine, 2-methylbenzene-1,3-diamine, 5-methylbenzene-1,3-diamine, 5-(trifluoromethyl)benzene-1,3-diamine, 4-(4-aminophenoxy)aniline, 2-(4-aminophenyl)-1H-benzimidazol-5-amine, 4-[4-amino-2-(trifluoromethyl)phenyl]-3-(trifluoromethyl)aniline, 4,4-bis-(3-amino-4-hydroxyphenyl)-valeric acid, 2,2-bis(3-amino-4-hydroxyphenyl)hexafluoropropane, 2,2-bis(3-amino-4-methylphenyl)hexafluoropropane, tetrabromo methylenedianiline, 2,7-diamino-9-fluorenone, 2,2-bis(3-aminophenyl)hexafluoropropane, bis-(3-amino-4-chloro-phenyl)-methanone, bis-(3-amino-4-dimethylamino-phenyl)-methanone, 3-[3-amino-5-(trifluoromethyl)benzyl]-5-(trifluoromethyl)aniline, 1,5-diaminonaphthalene, benzidine-3,3′-dicarboxylic acid, 4,4′-diamino-1,1′-binaphthyl, 4,4′-diaminodiphenyl-3,3′-diglycolic acid, dihydroethidium, o-dianisidine, 2,2′-dichloro-5,5′-dimethoxybenzidine, 3-methoxybenzidine, 3,3′-dichlorobenzidine (diphenyl-d6), 2,2′-bis(trifluoromethyl)benzidine, 3,3′-bis(trifluoromethyl)benzidine, 3,3′-dichlorobenzidine-d6, tetramethylbenzidine, di-(aminophenyl)alkylen and
from amino compounds listed below, which do not carry two amino groups and are taken as derivatives with at least one additional amino group:
aniline, 4-amino-2,3,5,6-tetrafluorobenzoic acid, 4-amino-3,5-diiodobenzoic acid, 4-amino-3-methylbenzoic acid, 4-amino-2-chlorobenzoic acid, 4-aminosalicylic acid, 4-aminobenzoic acid, 4-aminophthalic acid, 1-(4-aminophenyl)ethanol, 4-aminobenzyl alcohol, 4-amino-3-methoxybenzoic acid, 4-aminophenyl ethyl carbinol, 4-amino-3-nitrobenzoic acid, 4-amino-3,5-dinitrobenzoic acid, 4-amino-3,5-dichlorobenzoic acid, 4-amino-3-hydroxybenzoic acid, 4-aminobenzyl alcohol hydrochloride, 4-aminobenzoic acid hydrochloride, pararosaniline base, 4-amino-5-chloro-2-methoxybenzoic acid, 4-(hexafluoro-2-hydroxyisopropyl)aniline, piperazine-p-amino benzoate, 4-amino-3,5-dibromobenzoic acid, isonicotinic acid hydrazide p-aminosalicylate salt, 4-amino-3,5-diiodosalicylic acid, 4-amino-2-methoxybenzoic acid, 2-[2-(4-aminophenyl)-2-hydroxy-1-(hydroxymethyl)ethyl]isoindoline-1,3-dione, 4-amino-2-nitrobenzoic acid, ethyl 2-(4-aminophenyl)-3,3,3-trifluoro-2-hydroxypropanoate, ethyl 2-(4-amino-3-methylphenyl)-3,3,3-trifluoro-2-hydroxypropanoate, ethyl 2-(4-amino-3-methoxyphenyl)-3,3,3-trifluoro-2-hydroxypropanoate, 4-aminonaphthalene-1,8-dicarboxylic acid, 4-amino-3-chloro-5-methylbenzoic acid, 4-amino-2,6-dimethylbenzoic acid, 4-amino-3-fluorobenzoic acid, 4-amino-5-bromo-2-methoxybenzenecarboxylic acid, 3,3′-tolidine-5-sulfonic acid, or their derivatives, again with the proviso that compounds listed which do not carry two amino groups are taken as derivatives with at least one additional amino group. The diamine groups M¹, M² and M³ are commercially available or accessible by known methods. The second amino group is accessible for example by substitution reaction. Most preferably, M¹, M² and M³ are independently from each other selected from the group of the following compounds:

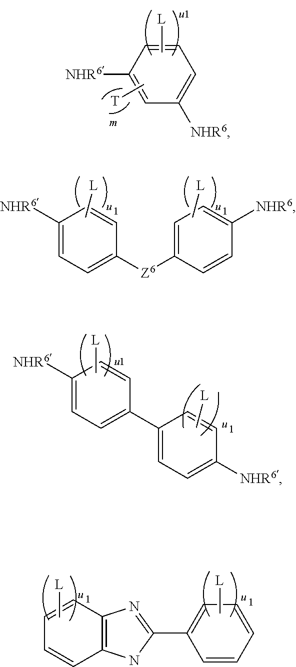

wherein
L is C₁-C₆alkyl, especially —CH₃, C₁-C₆alkylfluoro, especially —CF₃; —COCH₃, —OCH₃, nitro, cyano, halogen, especially fluoro, CH₂═CH—, CH₂═C(CH₃)—, CH₂═CH—(CO)O—, CH₂═CH—O—, —NR⁵R⁶, CH₂═C(CH₃)—(CO)O— or CH₂═C(CH₃)—O—, and preferably L is —CH₃ or —CF₃
T is a substituted or unsubstituted straight-chain or branched C₁-C₆alkanediyl group, in which one or more C—, CH—, —CH₂— group(s) may independently from each other be replaced by a heteroatom and/or by a bridging group; preferably T is a branched C₁-C₆alkanediyl, more preferably a branched C₃, C₄, C₅, C₆-alkanediyl group,
m is an integer of 0, 1 or 2;
u₁ is an integer from 0 to 3, with the proviso that m+u₁ is ≤3; and
R^{6′}, R⁶ each independently from each other represent a hydrogen atom or C₁-C₆alkyl; preferably are hydrogen, and
Z⁶ represents an unsubstituted or substituted straight-chain or branched C₁-C₁₄alkanediyl group, in which one or more, preferably non-adjacent, C—, CH—, CH₂— group may be replaced by an oxygen atom and/or one or more carbon-carbon single bond is replaced by a carbon-carbon double or a carbon-carbon triple bond; preferably Z⁶ is oxygen or a single bond;
and wherein
M¹ and M³ are independently from each other at least once linked to at least one group
S¹ in formula (I) via a single bond “—”; or via a side chain T; or via group Z⁶; if w¹ or w² are >1; and wherein
M² is at least once linked to at least one group R² in formula (I) via a single bond “—” or via a side chain T; or via group Z⁶; if w³ is >1.
D¹, D² and D³ of formula (I) preferably, represent independently from each other an unsubstituted or substituted aliphatic, alicyclic group or carbocyclic or heterocyclic aromatic group substituted with
   at least two carboxylic acid groups; or
   at least two activated carboxylic groups, preferably, two acyl groups and more preferably acid chloride, ester groups or carbonates, wherein the carbonate is preferably tert-butyl carbonates;
   or a di- tri- or tetra anhydride group, preferably with a dianhydride group, and most preferably a tetracarboxylic acid dianhydride.

The tetracarboxylic acid dianhydride of D¹, D² and D³ is independently from each other a tetracarboxylic acid dianhydride of formula (V)

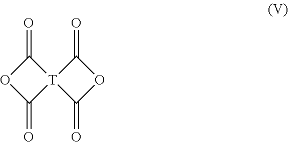

wherein:
T represents a tetravalent organic radical.

The tetravalent organic radical T is preferably derived from an aliphatic, alicyclic or aromatic tetracarboxylic acid dianhydride.

Preferred examples of aliphatic or alicyclic tetracarboxylic acid dianhydrides are:
1,2,3,4-cyclobutane tetracarboxylic dianhydride; 3-(carboxymethyl)-1,2,4-cyclopentane-tricarboxylicacid 1,4:2,3-dianhydride; 1,1,4,4-butanetetracarboxylic acid dianhydride; ethylenemaleic acid dianhydride; 1,2,3,4-cyclobutanetetracarboxylic acid dianhydride; 1,2,3,4-cyclopentanetetracarboxylic acid dianhydride;2,3,5-tricarboxycyclopentylacetic acid dianhydride; 3,5,6-tricarboxynorbornylacetic acid dianhydride; 2,3,4,5-tetrahydro-furantetracarboxylic acid dianhydride;rel-[1S,5R,6R]-3-oxabicyclo[3.2.1]octane-2,4-dione-6-spiro-3′-(tetrahydrofuran2′,5′-dione); 4-(2,5-dioxotetrahydrofuran-3-yl)-tetrahydronaphthalene-1,2-dicarboxylicacid dianhydride; 5-(2,5-dioxotetrahydrofuran-3-yl)-3-methyl-3-cyclohexene-1,2-dicarboxylic-acid dianhydride;
bicyclo[2.2.2]oct-7-ene-2,3,5,6-tetracarboxylic acid dianhydride;
bicyclo[2.2.2]octane-2,3,5,6-tetracarboxylic acid dianhydride;
1,8-dimethylbicyclo[2.2.2]oct-7-ene-2,3,5,6-tetracarboxylic acid dianhydride;
pyromellitic acid dianhydride; 3,3′,4,4′-benzophenonetetracarboxylic acid dianhydride;
4,4′-oxydiphthalic acid dianhydride; 3,3′,4,4′-diphenylsulfonetetracarboxylic acid dianhydride; 1,4,5,8-naphthalenetetracarboxylic acid dianhydride, 2,3,6,7-naphthalenetetracarboxylic acid dianhydride; 3,3′,4,4′-dimethyldiphenyl-silanetetracarboxylic acid dianhydride; 3,3′,4,4′-tetraphenylsilane-tetracarboxylic acid dianhydride; 1,2,3,4-furantetracarboxylic acid dianhydride;
4,4′-bis(3,4-dicarboxyphenoxy)diphenyl sulfide dianhydride;
4,4′-bis(3,4-dicarboxyphenoxy)diphenyl sulfone dianhydride;
4,4′-bis(3,4-dicarboxyphenoxy)diphenylpropane dianhydride;
3,3′,4,4′-biphenyltetracarboxylic acid dianhydride; ethylene glycol bis(trimellitic acid) dianhydride; 4,4′-(1,4-phenylene)bis(phthalic acid) dianhydride; 4,4′-(1,3-phenylene)-bis(phthalic acid) dianhydride; 4,4′-(hexafluoroisopropylidene)diphthalic acid dianhydride; 4,4′-oxydi(1,4-phenylene)bis(phthalic acid) dianhydride, and
4,4′-methylenedi(1,4-phenylene)bis(phthalic acid) dianhydride.

Preferred examples of aromatic tetracarboxylic acid dianhydrides are:
pyromellitic acid dianhydride; 3,3′,4,4′-benzophenonetetracarboxylic acid dianhydride; 4,4′-oxydiphthalic acid dianhydride;3,3′,4,4′-diphenylsulfonetetracarboxylic acid dianhydrid; 1,4,5,8-naphthalenetetracarboxylic acid dianhydride; 2,3,6,7-naphthalenetetra-carboxylic acid dianhydride; 3,3′,4,4′-dimethyldiphenylsilanetetracarboxylic acid dianhydride; 3,3′,4,4′-tetraphenylsilanetetracarboxylic acid dianhydride; 1,2,3,4-furan-tetracarboxylic acid dianhydride;4,4′-bis(3,4-dicarboxyphenoxy)diphenyl sulfide dianhydride; 4,4′-bis(3,4-dicarboxyphenoxy)diphenyl sulfone dianhydride; 4,4′-bis(3,4-dicarboxyphenoxy)diphenylpropane dianhydride; 3,3′,4,4′-biphenyl-tetracarboxylic acid dianhydride; ethylene glycol bis(trimellitic acid) dianhydride;
4,4′-(1,4-phenylene)bis(phthalic acid) dianhydride;4,4′-(1,3-phenylene)bis(phthalic acid) dianhydride; 4,4′-(hexafluoroisopropylidene)diphthalic acid dianhydride;
4,4′-oxydi(1,4-phenylene)bis(phthalic acid) dianhydride;4,4′-methylenedi(1,4-phenylene)bis(phthalic acid) dianhydride.

More preferably the tetracarboxylic acid dianhydrides used to form the tetravalent organic radical T are selected from:
1,2,3,4-cyclobutane tetracarboxylic dianhydride; 3-(carboxymethyl)-1,2,4-cyclopentanetricarboxylicacid 1,4:2,3-dianhydride; 1,2,3,4-cyclobutanetetra-carboxylic acid dianhydride; 1,2,3,4-cyclopentanetetracarboxylic acid dianhydride; 2,3,5-tricarboxycyclopentylacetic acid dianhydride;5-(2,5-dioxotetrahydrofuran-3-yl)-3-methyl-3-cyclohexene-1,2-dicarboxylic acid dianhydride; 4-(2,5-dioxotetrahydro-furan-3-yl)-tetrahydronaphthalene-1,2-dicarboxylic acid dianhydride;4,4′-(hexafluoro-isopropylidene)diphthalic acid dianhydride and
bicyclo[2.2.2]oct-7-ene-2,3,5,6-tetracarboxylic acid dianhydride.

In the context of the present invention preferred is
S¹ and S² of formula (I) which represent each independently from each other a single bond or a spacer unit, which is a cyclic, straight-chain or branched, substituted or unsubstituted C₁-C₂₀alkanediyl, in which one or more, preferably non-adjacent, C—, CH—, CH₂— group may be replaced by a linking group, and/or a non-aromatic, aromatic, unsubstituted or substituted carbocyclic or heterocyclic group of formula (IV):

—(Z¹—C¹)ₐ₁—(Z²—C²)ₐ₂—(Z^{1a})ₐ₃— (IV)
wherein:
C¹, C² each independently represents a non-aromatic, aromatic, optionally substituted carbocyclic or heterocyclic group, preferably connected to each other via the bridging groups Z¹ and Z² and/or Z^{1a}, preferably C₁ and C² are connected at the opposite positions via the bridging groups Z¹ and Z² and/or Z^{1a}, so that groups S¹ and/or S² have a long molecular axis, and
Z¹, Z², Z^{1a} each independently represents a bridging group, preferably selected from —CH(OH)—, —CH₂—, —O—, —CO—, —CH₂(CO)—, —SO—, —CH₂(SO)—, —SO₂—, —CH₂(SO₂)—, —(CO)O—, —O(CO)—, —(CO)CF₂—, —CF₂CO—, —S—CO—, —CO—S—, —SOO—, —OSO—, —SOS—, —CH₂—CH₂—, —OCH₂—, —CH₂O—, —CH═CH—, —C═C—, —CH═CH—(CO)O—, —O(CO)—CH═CH—, —CH═N—, —C(CH₃)=N—, —O—CO—O—, —N═N— or a single bond; and
a₁, a₂, as each independently represents an integer from 0 to 3, such that a₁+a₂+a₃≤6; preferably as is 0 and a₁+a₂≤4.

More preferred S¹ and S² each independently from each other represents a straight-chain or branched C₁-C₂₀alkylen, wherein one or more C—, CH—, CH₂— group may independently be replaced by a linking group or/and a group represented by the formula (IV), wherein:
C¹, C² are selected from a compound of group G¹, wherein group G¹ is:

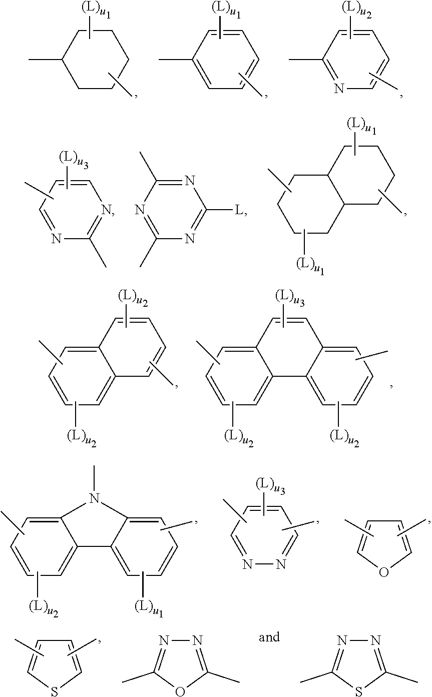

wherein:
“______” denotes the connecting bonds of C¹ and C² to the adjacent groups in formula (IV); and
L is —CH₃, —OCH₃, —COCH₃, nitro, cyano, halogen, CH₂═CH—, CH₂═C(CH₃)—, CH₂═CH—(CO)O—, CH₂═CH—O—, CH₂═C(CH₃)—(CO)O—, or CH₂═C(CH₃)—O—,
u₁ is an integer from 0 to 4; and
u₂ is an integer from 0 to 3; and
u₃ is an integer from 0 to 2; and
Z¹, Z², Z^{1a} each independently represents —O—, —CO—, —COO—, —OCO—, —COCF₂—, —CF₂CO—, —CH₂—CH₂—, —OCH₂—, —CH₂O—, —CH═CH—, —C═C—, —CH═CH—COO—, —OCO—CH═CH— or a single bond; with the proviso that heteroatoms are not directly linked to each other, and
a₁, a₂, as each independently represents an integer from 0 to 3, such that a₁+a₂+a₃≤6; preferably as is 0 and a₁+a₂≤4.

Most preferred S¹ and S² each independently from each other represents a single bond or a spacer unit such as a straight-chain or branched C₁-C₁₄alkanediyl wherein one or more, preferably non adjacent, C—, CH—, CH₂— group may independently be replaced by a linking group and/or a group represented by formula (IV), wherein:
C¹, C² each independently represents a 1,4-phenylene, 2-methoxy-1,4-phenylene, 1,4-cyclohexylene or a 4,4′-biphenylene group; and
Z¹, Z², Z^{1a} each independently represents —(CO)O—, —O(CO)—, —CH₂—CH₂—, —OCH₂—, —CH₂O—, —CH═CH—, —C≡C—, —CH═CH—(CO)O—, —O(CO)—CH═CH— or a single bond;
a₁, a₂, a₃ are independently 0 or 1, preferably a₃ is 0.

Especially most preferred S¹ and S² each independently from each other represent a straight-chain C₁-C₁₂alkanediyl, preferably C₁-C₆alkanediyl, and more preferably methylene, ethylene, propylene, butylene, oentylene, hexylene; wherein one or more C—, CH—, CH₂— group(s) may be replaced by —O—, —O(CO)—, —(CO)O—, preferably wherein C—, CH—, CH₂— group(s) are not replaced.

In the context of the present invention preferably,
E¹ and E² represent independently from each other a phenylene, an oxygen atom or a —N(H)— group; more preferred E¹ and E² are independently from each other oxygen or a —N(H)— group; most preferred E¹ and E² are oxygen.

In the context of the present invention preferably,
Z¹ and Z³ of formula (I) represent independently from each other a briding group which is selected from —(CO)O— or —O(CO)—; more preferably —O(CO)—;
Z² and Z⁴ of formula (I) represent independently from each other are —O—, or a single bond; more preferably Z² is a single bond and Z⁴ is —O—;
Q¹ and Q² of formula (I) preferably, represent independently from each other a single bond, a straight-chain or branched C₁-C₁₂alkanediyl, preferably, C₁-C₅alkanediyl, wherein one or more, preferably non-adjacent, C—, CH—, CH₂— group(s) may independently from each other be replaced by a group selected from —O—, —CO, —(CO)O—, —O(CO)—, —NR^{1′}—, —NR^{1′}—(CO)—, —(CO)—NR^{1′}—, —NR^{1′}—(CO)O—, —O(CO)—NR^{1′}—, —NR^{1′}—(CO)—NR¹—, —CH═CH—, —C≡C—, —O—CO—O—, and —Si(CH₃)₂—O—Si(CH₃)₂—, an aromatic and an alicyclic group; preferably selected from —O—, —CO, —(CO)O—, —O(CO)—, —NR¹—, —NR¹—CO—, —CO—NR¹— or —CH═CH—, more preferably a single bond or selected from selected from —O—, —CO—, —(CO)O—, —O(CO)—, and —CH═CH—; wherein:
   R^{1′} represents a hydrogen atom or C₁-C₆alkyl;
with the proviso that oxygen atoms are not directly linked to each other.

Further, in the context of the present invention preferably,
R¹ of formula (I) represents is hydrogen, C₁-C₆alkyl, wherein C₁-C₆alkyl is more preferably methyl or ethyl; or R¹ is a straight-chain or branched C₁-C₁₆fluoralkyl group, preferably selected from —CF₂H, —CF₃, —CF₂CF₃, —CF₂CHF₂, —(CF₂)₂CF₃, —(CF₂)₂CHF₂, —(CF₂)₃CHF₂, —(CF₂)₃CF₃, —CF(CF₃)₂ and —CF₂(CHF)CF₃, and more preferably selected from —CF₂H and —CF₃, and most preferably —CF₃;
R² of formula (I) preferably, represents hydrogen or a straight-chain or branched C₁-C₆alky, which is unsubstituted or substituted by di-(C₁-C₂₀alkyl)amino, C₁-C₆alkyloxy, nitro, cyano and/or chlorine or fluorine; and wherein one or more C—, CH—, CH₂— group may independently be replaced by a linking group;
preferably R² represents hydrogen, a straight-chain or branched C₁-C₆alkyl, more preferably methyl or ethyl, most preferably methyl; or a straight-chain or branched C₁-C₁₆fluoralkyl group, preferably selected from —CF₂H, —CF₃, —CF₂CF₃, —CF₂CHF₂, —(CF₂)₂CF₃, —(CF₂)₂CHF₂, —(CF₂)₃CHF₂, —(CF₂)₃CF₃, —CF(CF₃)₂ and —CF₂(CHF)CF₃, and more preferably selected from —CF₂H and —CF₃, and most preferably —CF₃;R³ of formula (I) preferably, represents hydrogen or a straight-chain or branched C₁-C₁₆fluoralkyl group, preferably selected from —CF₂H, —CF₃, —CF₂CF₃, —CF₂CHF₂, —(CF₂)₂CF₃, —(CF₂)₂CHF₂, —(CF₂)₃CHF₂, —(CF₂)₃CF₃, —CF(CF₃)₂ and —CF₂(CHF)CF₃, and more preferably selected from —CF₂H and —CF₃;
T¹, T², T³, T⁴ and T⁵ of formula (I) preferably, represent independently from each other hydrogen, fluorine and/or chlorine; substituted or unsubstituted, branched or straight-chain C₁-C₆alkyl, more preferably C₁-C₆alkyl, more is methyl, ethyl or trifluoromethyl;
more preferably T³ represents hydrogen or fluorine and T¹, T², T⁴ and T⁵ represent hydrogen;
n³, n⁴, n⁵, n⁶ and n⁷ of formula (I) preferably, represent independently from each
other 0 or 1; and more preferably n⁴, n⁵, n⁶ and n⁷ are 0 and n³ is 0 or 1, n¹ of formula (I) preferably, represents 0 or 1, more preferably 1;
w¹ and w² of formula (I) preferably, represent independently from each other 1 or 2, preferably 1;
w³ of formula (I) preferably, represents 0, 1 or 2.

A further preferred embodiment of the present invention relates to a compound of formula (I) as described above, wherein the terminal residue —Z⁴-Q²-R³ is:
trifluoromethyl; 2,2,2-trifluoroethyl; difluoromethyl; pentafluoroethyl; 2,2-tetrafluoroethyl; 3,2-tetrafluoroethyl; 3,3,3-trifluoropropyl; 2,2,3,3-tetrafluoropropyl; 2,2,3,3,3-pentafluoropropyl; hexafluoropropyl; heptafluoropropyl; 4,4,4-trifluorobutyl; tetrafluorobutyl; 3,3,4,4,4-pentafluorobutyl; hexafluorobutyl; 2,2,3,3,4,4,4-heptafluorobutyl; 5,5,5-trifluoropentyl; tetrafluoropentyl; 4,4,5,5,5-pentafluoropentyl; hexafluoropentyl; 3,3,4,4,5,5,5-heptafluoropentyl; 6,6,6-trifluorohexyl; tetrafluorohexyl; 5,5,6,6,6-pentafluorohexyl; hexafluorohexyl; 4,4,5,5,6,6,6-heptafluorohexyl; nonafluorohexyl; 1-trifluoro-1,2,2,2-tertafluoroethoxy, 2-trifluoro-2,3,3,3-tertafluoropropoxy, 3-trifluoro-3,4,4,4-tertafluorobutoxy, 4-trifluoro-4,5,5,5-tertafluoropentoxy, 5-trifluoro-5,6,6,6-tertafluorohexoxy, 6-trifluoro-6,7,7,7-tertafluoroheptoxy, 7-trifluoro-7,8,8,8-tertafluorononoxy;
fluoroalkoxy derivatives, such as trifluoromethoxy; 2,2,2-trifluoroethoxy; difluoromethoxy; pentafluoroethoxy; 1,1,2,2-tetrafluoroethoxy; 2,2,2,1-tetrafluoroethoxy; 3,3,3-trifluoropropoxy; 2,2,3,3-tetrafluoropropoxy; 2,2,3,3,3-pentafluoropropoxy; hexafluoropropoxyl; heptafluoropropoxy; 4,4,4-trifluorobutoxy; tetrafluorobutoxy; 3,3,4,4,4-pentafluorobutoxy; 2,2,3,3,4,4-hexafluorobutoxy; 2,2,3,3,4,4,4-heptafluorobutoxy; 5,5,5-trifluoropentoxy; tetrafluoropentoxy; 4,4,5,5,5-pentafluoropentoxy; hexafluoropentoxy; 3,3,4,4,5,5,5-heptafluoropentoxy; 6,6,6-trifluorohexoxy; tetrafluorohexoxy; 5,5,6,6,6-pentafluorohexoxy; hexafluorohexoxy; 4,4,5,5,6,6,6-heptafluorohexoxy; nonafluorohexoxy; trifluoromethylen carbamate; 2,2,2-trifluoroethylen carbamate; difluoromethylen carbamate; pentafluoroethylen carbamate; 2,2-tetrafluorethylen carbamate; 3,2-tetrafluorethylen carbamate; 3,3,3-trifluoropropylen carbamate; 2,2,3,3-tetrafluoropropylen carbamate; 2,2,3,3,3-pentafluoropropylen carbamate; hexafluoropropylen carbamate; heptafluoropropylen carbamate; 4,4,4-trifluorobutylen carbamate; tetrafluorobutylen carbamate; 3,3,4,4,4-pentafluorobutylen carbamate; hexafluorobutylen carbamate; 2,2,3,3,4,4,4-heptafluorobutylen carbamate; 5,5,5-trifluoropentylen carbamate; tetrafluoropentylen carbamate; 4,4,5,5,5-pentafluoropentylen carbamate; hexafluoropentylen carbamate; 3,3,4,4,5,5,5-heptafluoropentylen carbamate; 6,6,6-trifluorohexylen carbamate; tetrafluorohexylen carbamate; 5,5,6,6,6-pentafluorohexylen carbamate; hexafluorohexylen carbamate; 4,4,5,5,6,6,6-heptafluorohexylen carbamate; nonafluorohexylen carbamate;
fluoroalkyloyloxy derivatives, such as
trifluoromethyloyloxy; 2,2,2-trifluoroethyloyloxy; pentafluoroethyloyloxy; 1,1,2,2-tetrafluorethyloyloxy; 2,2,2,1-tetrafluorethyloyloxy; 3,3,3-trifluoropropyloyloxy; tetrafluoropropyloyloxy; 2,2,3,3,3-pentafluoropropyloyloxy; hexafluoropropyloyloxy; 1,1,2,2,3,3,3-heptafluoropropyloyloxy; 4,4,4-trifluorobutyloyloxy; tetrafluorobutyloyloxy; 3,3,4,4,4-pentafluorobutyloyloxy; hexafluorobutyloyloxy; 2,2,3,3,4,4,4-heptafluorobutyloyloxy; 5,5,5-trifluoropentyloyloxy; tetrafluoropentyloyloxy; 4,4,5,5,5-pentafluoropentyloyloxy; hexafluoropentyloyloxy; 3,3,4,4,5,5,5-heptafluoropentyloyloxy; 6,6,6-trifluorohexyloyloxy; tetrafluorohexyloyloxy; 5,5,6,6,6-pentafluorohexyloyloxy; hexafluorohexyloyloxy; 4,4,5,5,6,6,6-heptafluorohexyloyloxy;
trifluoroacetyl; nonafluorohexyloyloxy; 4,4,4-trifluorobut-2-enyl; 5,5,5-trifluoropent-1-enyl; 6,6,6-trifluorohex-1-enyl; 7,7,7-trifluorohept-1-enyl; trifluoroacetylaminomethoxy; trifluoroacetylaminoethoxy; trifluoroacetylaminopropoxy; trifluoroacetylaminobutoxy; 2-fluoroethyl; 3-fluoropropyl; 4-fluorobutyl; 5-fluoropentyl; 6-fluorohexyl; 2-fluoroethoxy; 3-fluoropropoxy; 4-fluorobutoxy; 5-fluoropentoxy; 6-fluorohexyloxy; 4-fluorobut-1-enyl; 5-fluoropent-1-enyl; 6-fluorohex-1-enyl; 7-fluorohept-1-enyl; 4,4,4-trifluoro-3-(trifluoromethyl)butoxy; 4,5,5-trifluoropent-4-enoxy; 4,5,5-trifluoropent-4-enoyloxy; 5,6,6-trifluorohex-5-enoxy or 5,6,6-trifluoropent-5-enoyloxy;
especially preferred are fluoroalkoxy, preferably trifluor- and pentafluoro fluoroalkoxy derivatives, especially preferred are 4,4,4-trifluorobutoxy and 5,5,5-trifluoropentoxy, especially 4,4,4-trifluorobutoxy.

Preferred, the present invention relates to a compound of formula (I),
wherein
M¹, M² and M³ are independently from each other an optionally substituted aliphatic, alicyclic, aromatic or non-aromatic diamine group having from 1 to 40 carbon atoms selected from formula (III),

H(R^{6′})N-(Sp¹)ₖ₁-(X¹)ₜ₁—(Z⁵—C³)ₐ₃—(Z⁶—C⁴)ₐ₄—(X²)ₜ₂-(Sp²)ₖ₂-N(R⁶)H (III)
wherein
   k¹, k² are 0 or 1, and
   t¹, t² are 0, and
   R^{6′}, R⁶ are identical and represent a hydrogen atom, a methyl, an ethyl or an isopropyl group; and
   C₃, C₄ independently from each other are selected from compound of a group
   G² as described above;
   Z⁵ represents a group selected from —CH(OH)—, —CH(CH₃)—, —C(CH₃)₂—, —CO—, —(CO)O—, —O(CO)—, —COCF₂—, —CF₂CO— or a single bond; and
   Z⁶ has one of the meanings of Z⁵ or represents a substituted or unsubstituted straight-chain or branched C₁-C₂₀alkanediyl, in which one or more, preferably non-adjacent, C—, CH—, CH₂— group may indepentely from each other be replaced by cyclohexylen, phenylen, aromatic or non-aromatic N-heterocycle; or by a heteroatom and/or by an oxygen atom; and/or one or more carbon-carbon single bond is replaced by a carbon-carbon double or a carbon-carbon triple bond, preferably Z⁶ is oxygen or a single bond; and;
   a³, a⁴ each independently represents an integer from 0 to 2 such that a³+−a⁴≤3;
   Sp¹, Sp², X¹, X² have the same meaning as described above; and wherein
D¹, D² and D³ represent independently from each other an an unsubstituted or substituted aliphatic, alicyclic group or carbocyclic or heterocyclic aromatic group substituted with at least two carboxylic acid groups; or at least two activated carboxylic groups, preferably, two acyl groups; and more preferably acid chloride, ester groups or carbonates, wherein the carbonate is preferably tert-butyl carbonates;
   or a di- tri- or tetra anhydride group, preferably with a dianhydride group,
m¹, m² or m³ represent independently from each other molar fractions of the comonomers with 0<m¹<1, 0≤m²≤0, 7 and 0≤m³<1, preferably 0<m¹<1, 0≤m²≤0.5 and 0≤m³<1,
S¹ and S² represent independently from each other a single bond or a cyclic, straight-chain or branched, substituted or unsubstituted C₁-C₂₀alkanediyl, wherein one or more C—, CH—, CH₂— group may independently from each other be replaced by a linking group as described above;
E¹ and E² represent independently from each other a phenylene, an oxygen atom or a —N(H)— group; preferably an oxygen atom, and
Z¹, Z², Z³ and Z⁴ independently from each other are selected from —CO—, —(CO)O—, —O(CO)—, —O— or a single bond;
Q¹ and Q² represent independently from each other a single bond, or a straight-chain or branched C₁-C₁₂alkanediyl, preferably C₁-C₅alkanediyl, wherein one or more, preferably non-adjacent, C—, CH—, CH₂— group may independently from each other be replaced by a group selected from —O—, —CO, —(CO)O—, —O(CO)—, —NR^{1′}—, —NR^{1′}—CO—, —CO—NR^{1′}— or —CH═CH—, more preferably a single bond or selected from selected from —O—, —CO—, —(CO)O—, —O(CO)—, and —CH═CH—; wherein:
R^{1′} represents a hydrogen atom or C₁-C₆alkyl;
with the proviso that oxygen atoms are not directly linked to each other
R² represents hydrogen or a straight-chain or branched C₁-C₆alky, which is unsubstituted or substituted by di-(C₁-C₂₀alkyl)amino, C₁-C₆alkyloxy, nitro, cyano and/or chlorine or fluorine; and wherein one or more C—, CH—, CH₂— group may independently be replaced by a linking group, preferably R² represents is hydrogen, methyl or trifluoromethyl;
R³ represents a straight-chain or branched
   C₁-C₁₆fluoralkyl group with terminal units selected from —CF₂H or —CF₃, —CF₂CF₃, —CF₂CHF₂, —(CF₂)₂CF₃, —(CF₂)₂CHF₂, —(CF₂)₃CHF₂, —(CF₂)₃CF₃, —CF(CF₃)₂ and —CF₂(CHF)CF₃, and preferably selected from —CF₂H and —CF₃, and is more preferably —CF₃, and wherein
R¹ represents hydrogen or —CF₃, preferably hydrogen;
T¹, T², T³, T⁴ and T⁵ of formula (I) represent independently from each other hydrogen, fluorine and/or chlorine; substituted or unsubstituted, branched or straight-chain C₁-C₆alkyl, more preferably C₁-C₆alkyl, more is methyl, ethyl or trifluoromethyl;
   more preferably T³ represents hydrogen or fluorine and T¹, T², T⁴ and T⁵ represent hydrogen; n¹, n² represent independently from each other is 0, 1, 2 or 3, preferably 0, 1 or 2, and more preferably n¹ is 0 or 1, and n² is 0, 1 or 2;
n³, n⁴, n⁵, n⁶ and n⁷ of formula (I) represent independently from each other 0 or 1; and more preferably n⁴, n⁵, n⁶ and n⁷ are 0 and n³ is 0 or 1,
n¹ of formula (I) represents 0 or 1, more preferably 1;
w³ of formula (I) represents 0, 1 or 2;
   w¹ and w² of formula (I) preferably, represent independently from each other 1 or 2, preferably 1;
with the proviso that if w¹ and/or w² is 2, 3, or 4, each T¹, T², T³, T⁴ and T⁵, R¹ and R³,
Q¹ and Q², Z¹, Z², Z³ and Z⁴, E¹ and E², S¹, S², n¹, n³, n⁴, n⁵, n⁶ and n⁷ may be identical or different.

Further one preferred embodiment of the present invention relates to a compound of formula (I), wherein n¹ represent 1, and wherein n³ represents 1 and T¹ represents halogen, preferably fluoro, or
wherein n¹ represent 1, and wherein n³ represents 0, or
wherein n¹ represent 0 and wherein n³ represents 1 and T¹ represents halogen, preferably fluoro.

A further embodiment of the present invention is a composition comprising at least one compound of formula (I) and preferably at least one or two diamine (L), more preferably the diamine (L) is within the above given meanings and preferences as described for diamines M¹, M² and/or M³, especially those of formula (III).

Further more preferred the diamine (L) represents unsubstituted or substituted aliphatic, aromatic or alicyclic diamine group having from 1 to 40 carbon atoms and preferably made from or selected from the following group of structures:
p-phenylenediamine, m-phenylenediamine, benzidine, 3,3′-diaminodiphenylmethane, 4-(4-amino-2-methyl-phenyl)-3-methyl-aniline, 2-(trifluoromethyl)benzene-1,3-diamine, 2-methylbenzene-1,3-diamine, 5-methylbenzene-1,3-diamine, 5-(trifluoromethyl)benzene-1,3-diamine, 4-(4-aminophenoxy)aniline, 2-(4-aminophenyl)-1H-benzimidazol-5-amine,
4-[4-amino-2-(trifluoromethyl)phenyl]-3-(trifluoromethyl)aniline, phenoxybenzene or
   L represents diamine groups selected from the compounds given below and monodiamine compounds, which are substituted by a second diamine as given below:
aniline, phenoxybenzene, 4-amino-2,3,5,6-tetrafluorobenzoic acid, 4-amino-3,5-diiodobenzoic acid, 3,4-diaminobenzoic acid, 4-amino-3-methylbenzoic acid, 4-amino-2-chlorobenzoic acid, 4-aminosalicylic acid, 4-aminobenzoic acid, 4-aminophthalic acid, 1-(4-aminophenyl)-ethanol, 4-aminobenzyl alcohol, 4-amino-3-methoxybenzoic acid, 4-aminophenyl ethyl carbinol, 4-amino-3-nitrobenzoic acid, 4-amino-3,5-dinitrobenzoic acid, 4-amino-3,5-dichlorobenzoic acid, 4-amino-3-hydroxybenzoic acid, 4-aminobenzyl alcohol hydrochloride, 4-aminobenzoic acid hydrochloride pararosaniline base, 4-amino-5-chloro-2-methoxybenzoic acid, 4-(hexafluoro-2-hydroxyisopropyl)aniline, piperazine-p-amino benzoate, 4-amino-3,5-dibromobenzoic acid, isonicotinic acid hydrazide, p-aminosalicylate salt, 4-amino-3,5-diiodosalicylic acid, 4-amino-2-methoxybenzoic acid, 2-[2-(4-aminophenyl)-2-hydroxy-1-(hydroxymethyl)ethyl]-isoindoline-1,3-dione, 4-amino-2-nitrobenzoic acid, 2,4-diaminobenzoic acid, p-aminobenzoic acid, [3,5-3h]-4-amino-2-methoxybenzoic acid, L-(+)-threo-2-amino-1-(4-aminophenyl)-1,3-propanediol, L-(+)-threo-2-(N,N-dimethylamino)-1-(4-aminophenyl)-1,3-propanediol, ethyl 2-(4-aminophenyl)-3,3,3-trifluoro-2-hydroxypropanoate,
ethyl 2-(4-amino-3-methylphenyl)-3,3,3-trifluoro-2-hydroxypropanoate
ethyl 2-(4-amino-3-methoxyphenyl)-3,3,3-trifluoro-2-hydroxypropanoate
3,4-diaminobenzyl alcohol dihydrochloride, 4-aminonaphthalene-1,8-dicarboxylic acid, 4-amino-3-chloro-5-methylbenzoic acid, 4-amino-2,6-dimethylbenzoic acid, 4-amino-3-fluorobenzoic acid, 4-amino-5-bromo-2-methoxybenzenecarboxylic acid 2,7-diaminofluorene, 4,4′-diaminooctafluorobiphenyl, 3,3′-diaminobenzidine, 3,3′,5,5′-tetramethylbenzidine, 3,3′-dimethoxybenzidine, o-tolidine,3,3′-dinitrobenzidine 2-nitrobenzidine, 3,3′-dihydroxybenzidine, o-tolidine sulfone, benzidine, 3,3′-dichlorobenzidine, 2,2′,5,5′-tetrachlorobenzidine, benzidine-3,3′-dicarboxylic acid, 4,4′-diamino-1,1′-binaphthyl, 4,4′-diaminodiphenyl-3,3′-diglycolic acid, dihydroethidium, o-dianisidine, 2,2′-dichloro-5,5′-dimethoxybenzidine, 3-methoxybenzidine, 3,3′-dichlorobenzidine (diphenyl-d6), 2,7-diamino-9-fluorenone, 3,5,3′,5′-tetrabromo-biphenyl-4,4′-diamine, 2,2′-bis(trifluoromethyl)benzidine, 2,2′-dichloro[1,1′-biphenyl]-4,4′-diamine, 3,9-diamino-1,11-dimethyl-5,7-dihydro-dibenzo(a,c)cyclohepten-6-one 3,3′-bis(trifluoromethyl)benzidine, dibenzo(1,2)dithiine-3,8-diamine, 3,3′-tolidine-5-sulfonic acid, 3,3′-dichlorobenzidine-d6, tetramethylbenzidine, 3,3′-diamino-benzophenone, 3,3′-diaminodiphenylmethane, 4,4-bis-(3-amino-4-hydroxyphenyl)-valeric acid, 2,2-bis(3-amino-4-hydroxyphenyl)hexafluoropropane, 2,2-bis(3-amino-4-methylphenyl)-hexafluoropropane, tetrabromo methylenedianiline 2,7-diamino-9-fluorenone, 2,2-bis(3-aminophenyl)hexafluoropropane, bis-(3-amino-4-chloro-phenyl)-methanone, bis-(3-amino-4-dimethylamino-phenyl)-methanone, 3-[3-amino-5-(trifluoromethyl)benzyl]-5-(trifluoromethyl)aniline, 1,5-diaminonaphthalene
   or their derivatives, again with the proviso that compounds listed which do not carry two amino groups are taken as derivatives with at least one additional amino group.
   (L) diamine is preferred:
p-phenylenediamine, m-phenylenediamine, benzidine, 3,3′-diaminodiphenylmethane, 4-(4-amino-2-methyl-phenyl)-3-methyl-aniline, 2-(trifluoromethyl)benzene-1,3diamine,
2-methylbenzene-1,3-diamine, 5-methylbenzene-1,3-diamine, 5-(trifluoromethyl)benzene-1,3-diamine, 4-(4-aminophenoxy)aniline, 2-(4-aminophenyl)-1H-benzimidazol-5-amine,
4-[4-amino-2-(trifluoromethyl)phenyl]-3-(trifluoromethyl)aniline, phenoxybenzene, which are unsubstituted or substituted with methyl or trifluoromethyl.
   (L) diamine is further preferred:
ethylenediamine, 1,3-propylenediamine, 1,4-butylenediamine, 1,5-pentylenediamine,
1,6-hexylenediamine, 1,7-heptylenediamine, 1,8-octylenediamine,
1,9-nonylenediamine, 1,10-decylenediamine, 1,11-undecylenediamine,
1,12-dodecylenediamine, α,α′-diamino-m-xylene, α,α′-diamino-p-xylene, (5-amino-2,2,4-trimethylcyclopentyl)methylamine, 1,2-diaminocyclohexane,
4,4′-diaminodicyclohexylmethane, 1,3-bis(methylamino)cyclohexane,
4,9-dioxadodecane-1,12-diamine, 3,5-diaminobenzoic acid methyl ester,
3,5-diaminobenzoic acid hexyl ester, 3,5-diaminobenzoic acid dodecyl ester,
3,5-diaminobenzoic acid isopropyl ester, 4,4′-methylenedianiline, 4,4′-ethylenedianiline,
4,4′-diamino-3,3′-dimethyldiphenylmethane, 3,3′,5,5′-tetramethylbenzidine,
4,4′-diaminodiphenyl sulfone, 4,4′-diaminodiphenyl ether,
1,5-diaminonaphthalene,3,3′-dimethyl-4,4′-diaminobiphenyl,
3,4′-diaminodiphenyl ether, 3,3′-diaminobenzophenone, 4,4′-diaminobenzophenone,
4,4′-diamino-2,2′-dimethylbibenzyl, bis[4-(4-aminophenoxy)phenyl]sulfone,
1,4-bis(4-aminophenoxy)benzene, 1,3-bis(4-aminophenoxy)benzene,
1,3-bis(3-aminophenoxy)benzene, 2,7-diaminofluorene,
9,9-bis(4-aminophenyl)fluorene, 4,4′-methylenebis(2-chloroaniline),
4,4′-bis(4-aminophenoxy)biphenyl, 2,2′,5,5′-tetrachloro-4,4′-diaminobiphenyl,
2,2′-dichloro-4,4′-diamino-5,5′-dimethoxybiphenyl, 3,3′-dimethoxy-4,4′-diaminobiphenyl,
4,4′-(1,4-phenyleneisopropylidene)bisaniline, 4,4′-(1,3-phenyleneisopropylidene)bisaniline, 2,2-bis[4-(4-aminophenoxy)phenyl]propane, 2,2-bis[3-(4- aminophenoxy)phenyl]hexa fluoropropane, 2,2-bis[3-amino-4-methylphenyl]hexafluoropropane, 2,2-bis(4-aminophen yl)hexafluoropropane, 2,2′-bis[4-(4-amino-2-trifluoromethylphenoxy)phenyl]hexafluoropropane, 4,4′-diamino-2,2′-bis(trifluoromethyl)biphenyl, and
4,4′-bis[(4-amino-2-trifluoromethyl)phenoxy]-2,3,5,6,2′,3′,5′,6′-octafluorobiphenyl;
   as well as diamines (L) disclosed in U.S. Pat. No. 6,340,506, WO 00/59966 and WO 01/53384, all of which are explicitely incorporated herein by reference;

The diamine compounds (L) according to the present invention may be prepared using methods that are known to a person skilled in the art.

(L) diamine is further preferred, which is commercially available and listed below:

### Polymers:

Poly(3,3′,4,4′-benzophenonetetracarboxylic dianhydride-co-4,4′-oxydianiline/1,3-phenylenediamine), amic acid solution
Poly(3,3′,4,4′-benzophenonetetracarboxylic dianhydride-co-4,4′-oxydianiline/1,3-phenylenediamine), amic acid solution
Poly(pyromellitic dianhydride-co-4,4′-oxydianiline), amic acid solution

### Aromatic Diamine

2,7-diaminofluorene, 1,5-diaminoanthraquinone, 2,6-diaminoanthraquinone, pararosaniline hydrochloride, 3,6-acridinediamine, 4,4′-diaminooctafluorobiphenyl, 2,2′-dithiodianiline,
3,3′,5,5′-tetramethylbenzidine, 3,3′-diaminodiphenyl sulfone, 4,4′-diamino-2,2′-dimethylbibenzyl,
4,4′-diaminodiphenyl ether, 4,4′-dithiodianiline, 4,4′-diaminodiphenyl sulfone, 4,4′-diamino-diphenylmethane, 4,4′-ethylenedianiline, 3,3′-dimethoxybenzidine, 2,2′-dithiobis(1-naphthylamine), 3,7-diamino-2-methoxyfluorene, 3,6-diamino-10-methylacridinium chloride
propidium iodide, o-dianisidine dihydrochloride, 2,7-diaminofluorene dihydrochloride pararosaniline acetate, 3,6-diamino-10-methylacridinium chloride hydrochloride proflavine dihydrochloride,o-tolidine dihydrochloride,3,3′,5,5′-tetramethylbenzidine, dihydrochloride, 3,3′-diaminobenzidine tetrahydrochloride, 4,4′-diaminostilbene dihydrochloride
4,4′-diaminodiphenylamine sulfate, proflavine hemisulfate,2,2′-ethylenedianiline diphosphate
1,5-diamino-4,8-dihydroxyanthraquinone, o-tolidine, 3,3′-diaminobenzophenone,3,3′-diamino-diphenylmethane, 3,4′-diaminodiphenylmethane, 2,2-bis[4-(4-aminophenoxy)-phenyl]hexafluoropropane,4,4′-diamino-1,1′-dianthramide, 3,3′-dinitrobenzidine 4,4′-diamino-5,5′-dimethyl-2,2′-biphenyldisulfonic acid, 4,4′-diaminostilbene-2,2′-disulfonic acid
3-amino-4-hydroxyphenyl sulfone, 4,4-bis-(3-amino-4-hydroxyphenyl)-valeric acid, 2,2′-diamino-4,4′-difluorobibenzyl, 2-amino-4-chlorophenyl disulfide, 3,3′-(decamethylene-dioxy)dianiline, 3,3′-(pentamethylenedioxy)dianiline, 4-(p-aminoanilino)-3-sulfoaniline,
4-[3-(4-aminophenoxy)propoxy]aniline, 2-nitrobenzidine,benzidine-3-sulfonic acid, 4,4′-diaminodiphenyl sulfide, 4,4′-diaminobenzanilide,n,n′-bis(3-aminophenylsulfonyl)-ethylenediamine, 2,2′-biphenyldiamine, 3,4′-diaminodiphenyl ether, proflavine hemisulphate,
Phenosafranin, 4,4′-diaminobenzophenone, 2,2-bis(4-aminophenyl)hexafluoropropane, 2,2-bis(3-amino-4-hydroxyphenyl)hexafluoropropane, 2,2-bis(3-amino-4-methylphenyl)-hexafluoropropane, 3,3′-dihydroxybenzidine, 3,3′-diamino-4,4′-dihydroxybiphenyl, 4,4′-bis(4-aminophenoxy)biphenyl, 2,2-bis[4-(4-aminophenoxy)phenyl]propane, 1,4-bis(4-aminophenoxy)benzene, 1,3-bis(4-aminophenoxy)benzene, bis[4-(4-aminophenoxy)phenyl]sulfone, 9,9-bis(4-aminophenyl)fluorene, o-tolidine sulfone, benzidine,
3,3′-dichlorobenzidine dihydrochloride, benzidine dihydrochloride,3,6-thioxanthenediamine-10,10-dioxide, 4,4′-diamino-2,2′-biphenyldisulfonic acid, 4,4′-azodianiline, 2,5-bis-(4-aminophenyl)-(1,3,4)oxadiazole, 3,3′-dimethylnaphthidine, benzidine sulfate, 1,3-bis(3-aminophenoxy)benzene, 3,3′-dichlorobenzidine, 2,2′,5,5′-tetrachlorobenzidine, 4,4′-diamino-1,1′-binaphthyl, diamine bordeaux, benzoflavin, chrysaniline, 2,2′-thiobis(5-aminobenzenesulfonic-acid), 4,4′-methylene-bis(2-chloroaniline), tetrabromo methylenedianiline, 4,4′-diamino-3,3′-dinitrodiphenyl ether, benzidine pyrophosphate, 3,6-diaminothioxanthene-10-dioxide, dihcl 4,4″-diamino-p-terphenyl, 1,8-diamino-4,5-dihydroxyanthraquinone,bis(p-aminophenoxy)-dimethylsilane, bis[4-(3-aminophenoxy)phenyl]sulfone, 4,4′-methylenedi-2,6-xylidine,
2-aminobenzaldehyde-ethylene-diimine,3-methylbenzidine dihydrochloride, 3,3′-diethylbenzidine dihydrochloride, 3,6-diaminoacridine hydrochloride, 4,4′-diamino-5,5′-dimethyl-2,2′-biphenyl disulfonic acid disodium salt,4,4′-methylenebis(3-chloro-2,6-diethylaniline), 4,4′-methylene-bis-(2,6-diethylaniline), 4,4′-methylenebis-(2,6-diisopropylaniline)
Toluylenediamine. 3,8-diamino-6-phenylphenanthridine, thionin perchlorate, dihydroethidium
Thionin, 4,4-diamino benzene sulfonyl anilide,o-dianisidine hcl, 2,2′-dichloro-5,5′-dimethoxy-benzidine, 3-methoxybenzidine,2,2′-(hexamethylenedioxy)dianiline,2,2′-(pentamethylene-dioxy)dianiline, 2,2′-(ethylenedioxy)dianiline, 4-[4-(4-aminophenoxy)butoxy]aniline
2,2′-diamino-4′-methoxy-4-methylbenzanilide, 5,5′-dimethyl-2,2′-dinitrobenzidine,
n,n′-bis(2-aminophenyl)-1,3-propanediamine, 3,4′-diaminochalcone, 2,3′,4,5′,6-pentaphenyl-3,4′-biphenyldiamine, 2-([1-(4-(1-[(2-aminophenyl)thio]-2-nitroethyl)phenyl)-2-nitroethyl]thio)anilin,
2-((2-[(2-aminophenyl)thio]ethyl)thio)aniline, 2-((4-[(2-aminophenyl)thio]but-2-enyl)thio)aniline,
4,4′-diamino-3,3′-dimethyldiphenyl methane, 2,2′-diamino-bibenzyl, trimethylene bis(4-aminobenzoate), fluoresceinamine, benzidines mixture, 3-nitro-4,4′-methylenedianiline 4,4-diamino-2,2′-dichlorodiphenyl disulfide, 1,6-diaminopyrene, 1,8-diaminopyrene, 3,6-diaminocarbazole, 4,4′(5′)-diamino-[2,4]-dibenzo-18-crown-6,dihydrochloride, 4,4′-diaminostilbene-2,2′-disulfonic acid, disodium salt, (r)-(+)-2,2′-diamino-1,1′-binaphthyl,
proflavine hemisulfate dihydrate, 3,6-diaminoacridine hemisulfate hemihydrate, dimidium bromide monohydrate, o-tolidine dihydrochloride hydrate, 3,3′,5,5′-tetramethylbenzidine dihydrochloride hydrate, 3,3′-diaminobenzidine tetrahydrochloride dihydrate, 3,6-[bis(4-amino-3-(sodiumsulphonato)phenlamino)]-2,5-dichloro 4-benzoquinone, 2,2′-dimethylbenzidine hydro-chloride, 2,2′-(phenylmethylenebis)bis(4-methylaniline), 3,4′-diaminobiphenyl,2,7-diamino-9-fluorenone, n,n′-bis(2-aminophenyl)oxamide, 2-[2-(2-aminophenyl)diaz-1-enyl]aniline, 3,5,3′,5′-tetrabromo-biphenyl-4,4′-diamine, n,n′-bis(4-aminophenyl)-1,3 bis(aminomethyl-)benzene dihydrochloride, 4′,4″(5″)-diaminodibenzo-15-crown-5,2,2′-bis(trifluoromethyl)benzidine,
bis(4-amino-2,3-dichlorophenyl)methane,alpha,alpha′-bis(4-aminophenyl)-1,4-diisopropylbenzene, 2,2-bis(3-aminophenyl)hexafluoropropane, 3,10-diamino-6,13-dichlorobenzo[5,6][1,4]oxazino[2,3-b]phenoxazine-4,11-disulfo, n1-(2-amino-4-methylphenyl)-2-aminobenzamide, n1-(2-amino-4-chlorophenyl)-2-aminobenzamide, 2,2′-dichloro[1,1′-biphenyl]-4,4′-diamine, 4,4′(5′)-diaminodibenzo-15-crown-5 dihydrochloride, is-(4-amino-3-nitro-phenyl)-methanone, bis-(3-amino-4-chloro-phenyl)-methanone, bis-(3-amino-4-dimethylamino-phenyl)-methanone, n,n′-bis-(4-amino-2-chloro-phenyl)-isophthalamide, n,n′-bis-(4-amino-2-chloro-phenyl)-terephthalamide, 3,9-diamino-1,11-dimethyl-5,7-dihydro-dibenzo(a,c)cyclohepten-6-one, 2-aminobenzaldehyde n-[(z)-(2-aminophenyl)methylidene]hydrazone, 3,3′-bis(trifluoromethyl)-benzidine,dicarboxidine 2 hcl, 4,4′-(1,3-phenylenediisopropylidene)bisaniline
1,4-phenylenebis[[4-(4-aminophenoxy)phenyl]methanone], 2-((5-[(2-aminophenyl)thio]-3,4-dinitro-2-thienyl)thio)aniline, n′1-(2-aminobenzoyl)-2-aminobenzene-1-carbohydrazide,
2-[4-(5-amino-1h-benzimidazol-2-yl)phenyl]-1 h-benzimidazol-5-amine, 4-[4-(4-aminophenoxy)-2,3,5,6-tetrafluorophenoxy]aniline, 3,3′-dinitro-4,4′-diaminodiphenyl sulfone, 3,3′,4,4′-tetraamino-diphenylsulfone, 4-[1-(4-aminophenyl)-1-methylethyl]aniline, 3,3-diamino diphenyl urea,
bis(4-aminophenyl)acetylene, dibenzo(1,2)dithiine-3,8-diamine, ethidium homodimer-2, 4.4′-bis-(2-aminobenzenesulfonyl)bis-phenolester,neopentyl glycol bis(4-aminophenyl) ether,
2,2′-oxydianiline, 4,4′-diaminodiphenylamine-2,2-disulphonic acid, 4,4-diamino diphenyl urea,
3,3′-tolidine-5-sulfonic acid, n1-(3-[(2-aminobenzoyl)amino]propyl)-2-aminobenzamide, 2-((6-[(2-aminophenyl)sulfanyl]-5-nitro-2-pyridyl)sulfanyl)aniline, 2-((6-amino-1,3-benzothiazol-2-yl)dithio)-1,3-benzothiazol-6-ylamine, tetramethylbenzidine, 2-([6-[(2-aminophenyl)sulfanyl]-3,5-di(trifluoromethyl)-2-pyridyl]sulfanyl) anile, 3,6-diaminothioxanthene-10-dioxide dihydrochloride
m-tolidine dihydrochloride hydrate, 2-amino-n-[2-amino-4-(trifluoromethyl)phenyl]-5-methylbenzamide, 2-([2-[(2-aminophenyl)thio]-6-nitro-4-(trifluoromethyl)phenyl]thio)aniline,
2-[(3-([(2-aminophenyl)thio]methyl)-2,4,6-trimethylbenzyl)thio]aniline, 3-[3-amino-5-(trifluoromethyl)benzyl]-5-(trifluoromethyl)aniline, 2-((5-[(2-aminophenyl)thio]-4-chloro-2-nitrophenyl)thio)aniline, 4-(1-(4-aminophenyl)-2-[4-(dimethylamino)phenyl]vinyl)aniline
1,5-bis(4-aminophenoxy)pentane, 2,3′-dichlorobenzidine dihydrochloride, 3,3′-diamono-4,4′-dichlorodiphenyl sulfone, 3-(bis-(4-amino-phenyl)-methyl)-2,3-dihydro-isoindol-1-one, 4,4-diamino diphenyl-2-sulphonic acid, 4,4′-diamino-diphenylene-cycylohexane
4,5′-diamino-(1,1′)bianthracenyl-9,10,9′,10′-tetraone

### Alicyclic Diamines

4,4′-methylenebis(cyclohexylamine), 4,4′-methylenebis(2-methylcyclohexylamine)

### Aliphatic Diamines

1,8-diamino-p-menthane, 4,4′-methylenebis(cyclohexylamine), d-cystine, l-cystine dimethyl, ester dihydrochloride, neamine, bis(2-aminopropyl)amine, l-cystine dibenzyl ester ditosylate, 1,4-diaminocyclohexane, dl-2-aminopropionic anhydride,
l-cystine(di-b-naphthylamide)hydrochloride, l-cystine-bis-p-nitroanilide dihydrobromide, l-cystine diethyl ester dihydrochloride, trans-1,4-cyclohexanediamine, 4,4′-methylenebis(2-methylcyclohexylamine), l-leucinethiol, oxidized dihydrochloride, 1,3-diaminoadamantane dihydrochloride, l-leucinethiol disulfide 2 hcl, l-cystine disodium salt, monohydrate,
l-homocystine methylester hydrochloride, 1,3-adamantanediamine, tetracyclo-[8.2.1.1(8,11).0(2,7)-]tetradeca-2,4,6-triene-10,11-diamine,tricyclo[3.3.1.0(3,7)]nonane-3,7-diamine

From the class of commercially available diamines (L) preferred are the below listed ones:

### Alicyclic Diamines

4,4′-methylenebis(cyclohexylamine), 4,4′-methylenebis(2-methylcyclohexylamine)

### Aliphatic Diamines

4,4′-methylenebis(cyclohexylamine), 1.4-diaminocyclohexane, trans-1,4-cyclohexanediamine,
4,4′-methylenebis(2-methylcyclohexylamine), 1,3-adamantanediamine

### Aromatic Diamines

2,7-diaminofluorene, 2,6-diaminoanthraquinone, 4,4′-diaminooctafluorobiphenyl, 4,4′-diaminodiphenyl ether, 4,4′-dithiodianiline, 4,4′-diaminodiphenylmethane,
4,4′-ethylenedianiline, 3,3′-dimethoxybenzidine, o-tolidine, 3,3′-diaminobenzophenone 3,3′-diaminodiphenylmethane, 3,4′-diaminodiphenylmethane,2,2-bis[4-(4-aminophenoxy)phenyl]hexafluoropropane, 4-[3-(4-aminophenoxy)propoxy]aniline-4,4′-diaminodiphenyl sulfide, 4,4′-diaminobenzophenone, 2,2-bis(4-aminophenyl)hexafluoropropane, 4,4′-bis(4-aminophenoxy)biphenyl,2,2-bis[4-(4-aminophenoxy)phenyl]propane, 1,4-bis(4-aminophenoxy)benzene, 1,3-bis(4-aminophenoxy)benzene, bis[4-(4-aminophenoxy)phenyl]sulfone, 9,9-bis(4-aminophenyl)fluorene, benzidine, 4,4′-azodianiline,1,3-bis(3-aminophenoxy)benzene 4,4′-diamino-1,1′-binaphthyl, 4,4″-diamino-p-terphenyl, bis(p-aminophenoxy)dimethylsilane
4-[4-(4-aminophenoxy)butoxy]aniline, 3,4′-diaminochalcone, trimethylene bis(4-aminobenzoate),
3,4′-diaminobiphenyl, 2,7-diamino-9-fluorenonex, 4′,4″(5″)-diaminodibenzo-15-crown-5,
2,2′-bis(trifluoromethyl)benzidine, alpha,alpha′-bis(4-aminophenyl)-1,4-diisopropylbenzene,
3,3′-bis(trifluoromethyl)benzidine,4,4′-(1,3-phenylenediisopropylidene)bisaniline, 1,4-phenylenebis-[[4-(4-aminophenoxy)phenyl]methanone], 4-[4-(4-aminophenoxy)-2,3,5,6-tetrafluorophenoxy]aniline, 4-[1-(4-aminophenyl)-1-methylethyl]aniline, neopentyl glycol bis(4-aminophenyl) ether, 4,4-diamino diphenyl, 1,5-bis(4-aminophenoxy)pentane

From the class of commercially available diamines (L) more preferred are the below listed ones:

### Aromatic Diamines

2,7-diaminofluorene, 4,4′-diaminooctafluorobiphenyl, 4,4′-diaminodiphenyl ether, 4,4′-diaminodiphenylmethane, 4,4′-ethylenedianiline, 3,3′-diaminobenzophenone, 4-[3-(4-aminophenoxy)propoxy]aniline, 4,4′-diaminodiphenyl sulfide, 4,4′-diaminobenzophenone,
2,2-bis(4-aminophenyl)hexafluoropropane, 4,4′-bis(4-aminophenoxy)biphenyl, 2,2-bis[4-(4-aminophenoxy)phenyl]propane, 1,4-bis(4-aminophenoxy)benzene, 1,3-bis(4-aminophenoxy)benzene, 9,9-bis(4-aminophenyl)fluorene, benzidine, bis(p-aminophenoxy)-dimethylsilane, 4-[4-(4-aminophenoxy)butoxy]aniline, 3,4′-diaminochalcone, trimethylene bis(4-aminobenzoate),3,4′-diaminobiphenyl, 2,7-diamino-9-fluorenone, 4′,4″(5″)-diaminodibenzo-15-crown-5, 4-[4-(4-aminophenoxy)-2,3,5,6-tetrafluorophenoxy]aniline, 4-[1-(4-aminophenyl)-1-methylethyl]aniline, 1,5-bis(4-aminophenoxy)pentane

### Aliphatic Diamines

4,4′-methylenebis(cyclohexylamine), 1,4-diaminocyclohexane

### Alicyclic Diamines

4,4′-methylenebis(cyclohexylamine)

Preferred is a composition comprising at least one compound of formula (I), within the meaning and preferences as described above,
a diamine (L), which is
p-phenylenediamine, m-phenylenediamine, benzidine, 3,3′-diaminodiphenylmethane, 4-(4-amino-2-methyl-phenyl)-3-methyl-aniline, 2-(trifluoromethyl)benzene-1,3-diamine, 2-methylbenzene-1,3-diamine, 5-methylbenzene-1,3-diamine, 5-(trifluoromethyl)benzene-1,3-diamine, 4-(4-aminophenoxy)aniline, 2-(4-aminophenyl)-1H-benzimidazol-5-amine, 4-[4-amino-2-(trifluoromethyl)phenyl]-3-(trifluoromethyl)aniline, phenoxybenzene.

A further embodiment of the present invention is a composition comprising at least one compound of formula (I), or a composition as described above, within the meaning and preferences as described above, and an additive.

Additives such as silane-containing compounds and epoxy-containing crosslinking agents may be added.

Suitable silane-containing additives are described in Plast. Eng. 36 (1996), (Polyimides, fundamentals and applications), Marcel Dekker, Inc.

Suitable epoxy-containing cross-linking additives include
4,4′-methylene-bis-(N,N-diglycidylaniline), trimethylolpropane triglycidyl ether, benzene-1,2,4,5-tetracarboxylic acid 1,2,4,5-N,N′-diglycidyldiimide, polyethylene glycol diglycidyl ether, N,N-diglycidylcyclohexylamine and the like.

Additional additives are photo-sensitizers, photo-radical generators, cationic photo-initiators.

Suitable photo-active additives include 2,2-dimethoxyphenylethanone, a mixture of diphenylmethanone and N,N-dimethylbenzenamine or ethyl 4-(dimethylamino)-benzoate, xanthone, thioxanthone, Irgacure® 184, 369, 500, 651 and 907 (Ciba), Michler's ketone, triaryl sulfonium salt and the like.

Further, preferably, the present invention relates to a composition, especially a blend, comprising
a polymer, copolymer or oligomer according to definition and preferences of the invention, comprising at least a compound (I), or
a polymer, copolymer or oligomer according to definition and preferences of the invention, obtainable by the processes of the invention,
and/or a further polymer, copolymer or oligomer comprising as one basic building block a diamine (L), or a further polymer, copolymer or oligomer, which is different from a polyamic acid, polyamic ester or a polyimide, more preferably a further polymer, copolymer or oligomer, which is selected from the group of polyacrylate, polystyrol, polyester, polyurethane, polyethylene, poylpopylen, polyvinylchloride, polytetrafluoroethylen, polycabonate, polyterephthalate and dendrimere.

Further preferably, the present invention relates to a composition, especially a blend, comprising
compound (I), or
compound (I), obtainable by the processes of the invention,
and an additive, preferably silane-containing compounds,
and/or a further polymer, copolymer or oligomer comprising as one basic building block a further diamine, which is different from diamine (I), preferably at least one diamine (L),
and/or a further polymer, copolymer or oligomer, which is different from a polyamic acid, polyamic ester or a polyimide, more preferably a further polymer, copolymer or oligomer, which is selected from the group of polymers include polyacrylates, polymethacrylates, polyacrylamides, polymethacrylamides, polyvinylether and polyvinylester, polyallylether and ester, polystyrenes, polysiloxanes, polyimides, polyamic acids and their esters, polyamidimides, polymaleic acids, polyfumaric acids polyurethanes and derivatives thereof,
and/or photo-active polymers, photo-active oligomers and/or photo-active monomers,
and/or cross-linking agents, preferably epoxy-containing cross-linking agents, most preferably selected from the group:
4,4′-methylene-bis-(N,N-diglycidylaniline), trimethylolpropane triglycidyl ether, benzene-1,2,4,5-tetracarboxylic acid 1,2,4,5-N,N′-diglycidyldiimide, polyethylene glycol diglycidyl ether, N,N-diglycidylcyclohexylamine.

In the context of the present invention the compound of formula (I) is a polymer, especially a copolymer or oligomer. Preferred the compound of formula (I) is a polyamic acid, polyamic ester, polyimide or a mixture thereof. Preferred compound of formula (I) is polyamic acid. If compound of formula (I) is a mixture, this mixture is preferably of polyamic acid and polyamic ester and/or polyimide. More preferred is a mixture of polyamic acid and polyimide.

In the context of the present invention the term “polyimide” has the meaning of partially or complete imidisated polyamic acid or polyamic ester. In analogy, the term “imidisation” has in the context of the present invention the meaning of partially or complete imidisation.

The polymer, copolymer or oligomer, especially the polyamic acid, polyamic acid ester and polyimide and mixtures thereof may be prepared in line with known methods, such as those described in Plast. Eng. 36 (1996), (Polyimides, fundamentals and applications), Marcel Dekker, Inc.

For example, the amidisation, poly-condensation reaction for the preparation of the polyamic acids is carried out in solution in a polar aprotic organic solvent, such as γ-butyrolactone, N,N-dimethylacetamide, N-methylpyrrolidone or N,N-dimethyl-formamide. In most cases equimolar amounts of the anhydride and the diamine are used, i.e., one amino group per anhydride group. If it is desired to stabilize the molecular weight of the polymer, copolymer or oligomer, it is possible for that purpose to either add an excess or a less-than-stoichiometric amount of one of the two components or to add a mono-functional compound in the form of a dicarboxylic acid monoanhydride or in the form of a monoamine. Examples of such mono-functional compounds are maleic acid anhydride, phthalic acid anhydride, aniline, and the like. Preferably the reaction is carried out at temperatures of less than 100° C.

The imidisation, cyclisation of the polyamic acids to form the polyimides can be carried out by heating, i.e., by condensation with removal of water or by other imidisation reactions using appropriate reagents.

Partially imidisation is achieved for example, if the imidisation is carried out purely thermally, the imidisation of the polyamic acids may not always be complete, i.e., the resulting polyimides may still contain proportions of polyamic acid.

Complete imidisation reactions are carried out at temperatures between 6° and 250° C., preferably at temperatures of less than 200° C.

In order to achieve imidisation at lower temperatures additional reagents that facilitate the removal of water are added to the reaction mixture. Such reagents are, for example, mixtures consisting of acid anhydrides, such as acetic acid anhydride, propionic acid anhydride, phthalic acid anhydride, trifluoroacetic acid anhydride or tertiary amines, such as triethylamine, trimethylamine, tributylamine, pyridine, N,N-dimethylaniline, lutidine, collidine etc. The amount of aforementioned additional reagents that facilitate the removal of water is preferably at least four equivalents of acid anhydride and two equivalents of amine per equivalent of polyamic acid to be condensed.

The imidization degree of each polymer used in the liquid crystal alignment agent of the invention can be arbitrarily adjusted by controlling the catalyst amount, reaction time and reaction temperature employed in production of the polymer. In the present description, “imidization degree” of polymer refers to a proportion (expressed in %) of the number of recurring units of polymer forming an imide ring or an isoimide ring to the number of total recurring units of polymer. In the present description, the imidization degree of a polyamic acid not subjected to dehydration and ring closure is 0%. The imidization degree of each polymer is determined by dissolving the polymer in deuterated dimethyl sulfoxide, subjecting the resulting solution to ¹H-NMR measurement at a room temperature using tetramethylsilane as a standard substance, and calculating from the following formula.

Imidization degree (%)=1−(A¹/A2×B)×100
A¹: Peak area based on protons of NH groups (in the vicinity of 10 ppm)
A²: Peak area based of one proton of acrylate double bond (in the vicinity of 6.5 ppm).
B: Proportion of the number of acrylate protons to one proton of NH group in the polymer precursor

The imidization degree is usually in the range of 1 to 99%, preferably 5 to 50%, more preferably 10 to 40%.

The present invention relates to a process for the preparation of a compound (I) comprising polymerisation of at least one of each a diamine M¹, M² and M³, withing the meanings and preferences as given above, with at least one D¹, D² and D³, withing the meanings and preferences as given above.

Preferably the polymerisation for the preparation of a compound (I) comprises
a) amidisation of at least one of each M¹, M² and M³, with at least one D¹, D² and D³, within the meanings and preferences as given above to polyamic acid or a polyamic ester, and/or
b) imidisation of the obtained polyamic acid or ester, to a polyimide, or
c) imidisation of the compound (I) to polyimide.

In a more preferred embodiment of the invention, the polymersiation of the diamine comprises the amidsation of at least one M¹, M² and M³, withing the meanings and preferences as given above, with tetracarboxylic acid anhydride (V), and/or the imidisation, preferably by elevated temperature, and wherein the amidisation and/or imidisation is optionally conducted
in the presence of additives as given above, and/or
in the presence of a further M¹, within the meanings and preferences as given above, which is different from that of M¹, M² and M³ in formula (I), preferably in the presence of at least one diamine (L) and/or
in the presence of a further polymer, copolymer or oligomer comprising as one basic building block a diamine (L), or a further polymer, copolymer or oligomer, which is different from a polyamic acid, polyamic ester or a polyimide, more preferably a further polymer, copolymer or oligomer, which is selected from the group of which is selected from the group of polymers include polyacrylates, polymethacrylates, polyacrylamides, polymethacrylamides, polyvinylether and polyvinylester, polyallylether and ester, polystyrenes, polysiloxanes, polyimides, polyamic acids and their esters, polyamidimides, polymaleic acids, polyfumaric acids polyurethanes and derivatives thereof.

Preferably, the further polymer, copolymer or oligomer comprises as basic building block a diamine (L) and a tetracarboxylic acid anhydride, preferably a tetracarboxylic acid anhydride of formula (V).

This polymer, copolymer or oligomer comprising as basic building block a diamine (L) is prepared in analogy to the polymer, copolymer or oligomer of the invention comprising compound (I).

The imidisation is conducted after or during amidisation. In general, the imidisation is conducted after amidisation.

Preferred is the partially imidisation of polyamic acid or polyamic ester.

If the polymer is prepared only by imidisation, compound (I) will be contacted with an imidisation compound, with at least two polymerisable functional groups, such as for example, carbonyl groups or halogen groups.

A further embodiment of the present invention relates to a compound (I), or a composition, within the meaning and preferences as described above, obtainable according to the processes and preferred processes of the invention.

The polymers or oligomers according to the invention may be used in form of polymer layers or oligomer layers alone or in combination with other polymers, oligomers, monomers, photo-active polymers, photo-active oligomers and/or photo-active monomers, depending upon the application to which the polymer or oligomer layer is to be added. Therefore, it is understood that by varying the composition of the polymer or oligomer layer it is possible to control specific and desired properties, such as an induced pre-tilt angle, good surface wetting, a high voltage holding ratio, a specific anchoring energy, etc.

Polymer or oligomer layers may readily be prepared from the polymers or oligomers of the present invention and a further embodiment of the invention relates to a polymer or oligomer layer comprising a polymer or oligomer according to the present invention, which is preferably prepared by treatment with aligning light. Preferably, the invention relates to a polymer or oligomer layer comprising a polymer or oligomer according to the present invention in a cross-linked and/or isomerized form.

The polymer or oligomer layer is preferably prepared by applying one or more polymers or oligomers according to the invention to a support and, after imidisation or without imidisation, treating, preferably cross-linking and/or isomerising, the polymer or oligomer or polymer mixture or oligomer mixture by irradiation with aligning light.

In the context of the present invention, aligning light is light of wavelengths, which can initiate photoalignment. Preferably, the wavelengths are in the UV-A, UV-B and/or UV-C-range, or in the visible range. It depends on the photoalignment compound, which wavelengths are appropriate. Preferably, the photo-reactive groups are sensitive to visible and/or UV light. A further embodiment of the invention concerns the generating of aligning light by laser light.

The instant direction of the aligning light may be normal to the substrate or at any oblique angle.

For generating tilt angles, preferably the aligning light is exposed from oblique angles. More preferably, aligning light is at least partially linearly polarized, elliptically polarized, such as for example circulary polarized, or non-polarized; most preferably at least circulary or partially linearly polarized light, or non-polarized light exposed obliquely. Especially, most preferred aligning light denotes substantially polarised light, especially linearly polarised light; or aligning light denotes non-polarised light, which is applied by an oblique irradiation.

In a more preferred embodiment of the invention the polymer, copolymer or oligomer is treated with polarised light, especially linearly polarised light, or by oblique radiation with non-polarised light.

In general, transparent support such as glass or plastic substrates, optionally coated with indium tin oxide (ITO) are used.

Further, it is possible to vary the direction of orientation and the tilt angle within the polymer or oligomer layer by controlling the direction of the irradiation of the aligning light. It is understood that by selectively irradiating specific regions of the polymer or oligomer layer very specific regions of the layer can be aligned. In this way, layers with a defined tilt angle can be provided. The induced orientation and tilt angle are retained in the polymer or oligomer layer by the process, especially by the process of cross-linking.

Further, the present invention relates to a method for the preparation of a compound, preferably a polymer, copolymer or oligomer according to the invention, wherein in a polycondensation reaction at least one of each M¹, M² and M³ diamine is reacted with one or more D¹, D² and D³, as described above withing the meaning and preferences given there; preferably with D¹, D² and D³ are tetracarboxylic acid dianhydrides of the general formula (V), optionally in the presence of one or more additional other diamines.

Further, the present invention preferably relates to a method, wherein a poly-condensation reaction for the preparation of the polyamic acids is carried out in solution in a polar aprotic organic solvent, preferably selected from y-butyrolactone N,N-dimethylacetamide, N-methylpyrrolidone or N,N-dimethylformamide

Preferably, the present invention relates to a method, wherein subsequent to the poly-condensation cyclisation with removal of water is carried out thermally under formation of a polyimide.

More preferably, the present invention relates to a method, wherein imidisation is carried out prior or after the application of the polymer, copolymer or oligomer to a support.

A further preferred embodiment of the present invention relates to a preferred methods of the invention relate to
a method for the preparation of a polymer layer or oligomer layer, which are vertically aligned;
a method for the preparation of multi-domain vertical alignment of a polymer layer or oligomer layer;
a method for the preparation of a polymer layer or oligomer layer with tilted optical axis.

A further embodiment of the present invention relates to a polymer, copolymer or oligomer layer, in particular orientation layer, comprising at least one polymer, copolymer or oligomer according to the present invention.

It is understood that the polymer or oligomer layers of the present invention (in form of a polymer gel, a polymer network, a polymer film, etc.) can also be used as orientation layers for liquid crystals. A further preferred embodiment of the invention relates to an orientation layer comprising one or more polymers or oligomers according to the invention, preferably in a cross-linked form. Such orientation layers can be used in the manufacture of unstructured or structured optical- or electro-optical elements, preferably in the production of hybrid layer elements.

In addition, the present invention relates to a method for the preparation of a polymer layer or oligomer layer, wherein one or more polymers, copolymers or oligomers according to the present invention is applied to a support, preferably from a solution of the polymer or oligomer material and subsequent evaporation of the solvent, and wherein, after any imidisation step which may be necessary, the polymer or oligomer or polymer mixture or oligomer mixture treated with aligning light, and preferably isomerized and/or cross-linked by irradiation with aligning light.

A preferred method of the present invention relates to a method, wherein the direction of orientation and the tilt angle within the polymer layer or oligomer layer is varied by controlling the direction of the irradiation with aligning light, and/or wherein by selectively irradiating specific regions of the polymer layer or oligomer layer specific regions of the layer are aligned.

The orientation layers are suitably prepared from a solution of the polymer or oligomer material. The polymer or oligomer solution is applied to a support optionally coated with an electrode [for example a glass plate coated with indium-tin oxide (ITO)] so that homogeneous layers of 0.05 to 50 μm thickness are produced. In this process different coating techniques like spin-coating, inkjet, meniscus-coating, wire-coating, slot-coating, offset-printing, flexo-printing, gravur-printing may be used. Then, or optionally after a prior imidisation step, the regions to be oriented are irradiated, for example, with a high-pressure mercury vapour lamp, a xenon lamp or a pulsed UV laser, using a polarizer and optionally a mask for creating images of structures.

Further, the present invention relates to the use of a polymer layer, copolymer or oligomer layer according to the present invention, preferably in cross-linked form, as an orientation layer for liquid crystals.

Further, the present invention relates to preferably the use of a polymer layer, copolymer or oligomer layer for the induction of vertical alignment of adjacent liquid crystalline layers, in particular for operating a cell in VA mode.

The irradiation time is dependent upon the output of the individual lamps and can vary from a few seconds to several hours. The photo-reaction (dimerisation, polymerisation, cross-linking) can also be carried out, however, by irradiation of the homogeneous layer using filters that, for example, allow only the radiation suitable for the cross-linking reaction to pass through.

It is understood that the polymer or oligomer layers of the invention may be used in the production of optical or electro-optical devices having at least one orientation layer as well as unstructured and structured optical elements and multi-layer systems.

The present invention relates to the use of a polymer layer, copolymer, or oligomer layer as an orientation layer for liquid crystals.

Preferred is the use for the induction of vertical alignment of adjacent liquid crystalline layers.

A further embodiment of the invention relates to an optical or electro-optical device comprising one or more polymers or oligomers according to the present invention in cross-linked form. The electro-optical devices may comprise more than one layer. The layer, or each of the layers may contain one or more regions of different spatial orientation.

Preferably, the present invention relates to an optical and electro-optical unstructured or structured constructional elements, preferably liquid crystal display cells, multi-layer and hybrid layer elements, comprising at least one polymer layer, copolymer or oligomer layer according to the present invention.

More preferably, the present invention relates to an orientation layer, comprising at least one polymer layer, copolymer or oligomer layer according to the present invention.

The advantages of the present invention could not be foreseen by a skilled person. It has surprisingly been found that low pre-tilt angles and/or low ACM values are assible by the compounds of present invention.

### EXAMPLES

### General Procedure for Polyamic Acid Formation

A polymer backbone which can be referred as polymer main chain is a polyimide or polyamic acid material. Polyamic acids (PAA) are precursor materials of polyimides (PI). This procedure follows the general procedure written in text books “Polyimides: Fundamentals and Application” where it involves reacting a dianhydride and a diamine in an aprotic solvent as a first stage to generate the Polyamic acid (PAA) intermediate polymer. PAA can be subsequently cyclized to the corresponding Polyimide (PI). Polyamic acids (PAA) were synthesized by “solution polycondensation” of diamines or mixture of diamines with dianhydrides or a mixture of dianhydrides and PAA were readily soluble in polar organic solvents (e.g. N-methylpyrrolidinone). The polymer composition is in accordance with the monomers (diamines, dianhydrides) structures with respect of their molar contribution and possible isomers. The polymer formation is characterized by an increase of the viscosity of the reaction mixture. An inherent viscosity >0.1 dL/g attests the formation of the polymer main chain.

### Definitions Used in the Examples

1H NMR: ¹H nuclear magnetic resonance spectroscopy
DMSO-de: dimethylsulfoxid deuterated
300 MHz: 300 MegaHertz
m: multiplet, d: doublet, dd: doublet doublet, t: triplet, s: singulet, b: broad
NMP: N-methyl-2-pyrrolidone
DMF: N,N-dimethylformamide
MeOH: methanol
GBL: Gamma-Butyrolactone
IBIB: Isobutyl Isobutyrate
DEE: Diethylene Glycol Diethyl Ether
wt %: weight percent
PTFE: Polytetrafluoroethylene
4,9-dioxatricyclo[5.3.0.0^{2,6}]decane-3,5,8,10-tetrone refers to 1,2,3,4-cyclobutane
tetracarboxylic dianhydride refers to CAS [4415-87-6],
4-(4-aminophenoxy) aniline refers to CAS [101-80-4],
4,10-dioxatricyclo[6.3.1.0^{2,7}]dodecane-3,5,9,11-tetrone refers to 3-(carboxymethyl)-1,2,4-cyclopentanetricarboxylicacid 1,4:2,3-dianhydride refers to CAS [6053-46-9],
4-(4-amino-2-methyl-phenyl)-3-methyl-aniline refers to CAS [84-67-3],
2-(4-aminophenyl)-1H-benzimidazol-5-amine refers to 5-amino-2-(4-aminophenyl)benzimidazole refers to CAS [7621-86-5],
2-methylbenzene-1,3-diamine refers to CAS [823-40-5],
5-(trifluoromethyl)benzene-1,3-diamine refers to CAS [368-53-6],
4-[4-amino-2-(trifluoromethyl)phenyl]-3-(trifluoromethyl)aniline refers to CAS [341-58-2]

### Example 1: Preparation of Polyamic Acid, PX1

4.897 g (24.970 mmol) of 4,9-dioxatricyclo[5.3.0.0^{2,6}]decane-3,5,8,10-tetrone is added to a solution of 5.000 g (24.970 mmol) of 4-(4-aminophenoxy) aniline in 39.59 g of NMP. Stirring is then carried out at 0° C. for 2 hours. The mixture is subsequently allowed to react for 72 hours at room temperature. Polyamic acid PX1 is obtained as 20 wt % NMP-solution with an inherent viscosity [η] of 0.37 dL/g.

### Example 2: Preparation of Polyamic Acid PX2

4.622 g (23.570 mmol) of 4,9-dioxatricyclo[5.3.0.0^{2,6}]decane-3,5,8,10-tetrone is added to a solution of 5.000 g (23.570 mmol) of 4-(4-amino-2-methyl-phenyl)-3-methyl-aniline in 38.49 g of NMP. Stirring is then carried out at 0° C. for 2 hours. The mixture is subsequently allowed to react for 72 hours at room temperature. Polyamic acid PX2 is obtained as 20 wt % NMP-solution with an inherent viscosity [η] of 0.50 dL/g.

### Example 3: Preparation of Polyamic Acid PX3

2.750 g (12.267 mmol) of 4,10-dioxatricyclo[6.3.1.0^{2,7}]dodecane-3,5,9,11-tetrone is added to a solution of 2.500 g (11.776 mmol) of 4-(4-amino-2-methyl-phenyl)-3-methyl-aniline and, 0.110 g (0.491 mmol) of 2-(4-aminophenyl)-1H-benzimidazol-5-amine in 21.44 g of NMP. Stirring is then carried out at 0° C. for 2 hours. The mixture is subsequently allowed to react for 72 hours at room temperature. Polyamic acid PX3 is obtained as 20 wt % NMP-solution with an inherent viscosity [η] of 0.57 dL/g.

### Example 4: Preparation of Polyamic Acid PX4

5.598 g (24.970 mmol) of 4,10-dioxatricyclo[6.3.1.0^{2,7}]dodecane-3,5,9,11-tetrone is added to a solution of 5.000 g (24.970 mmol) of 4-(4-aminophenoxy) aniline in 42.39 g of NMP. Stirring is then carried out at 0° C. for 2 hours. The mixture is subsequently allowed to react for 72 hours at room temperature. Polyamic acid PX4 is obtained as 20 wt % NMP-solution with an inherent viscosity [η] of 0.44 dL/g.

### Example 5: Preparation of Polyamic Acid PX5

5.284 g (23.570 mmol) of 4,10-dioxatricyclo[6.3.1.0^{2,7}]dodecane-3,5,9,11-tetrone is added to a solution of 5.000 g (23.570 mmol) of 4-(4-amino-2-methyl-phenyl)-3-methyl-aniline in 41.14 g of NMP. Stirring is then carried out at 0° C. for 2 hours. The mixture is subsequently allowed to react for 72 hours at room temperature. Polyamic acid PX5 is obtained as 20 wt % NMP-solution with an inherent viscosity [η] of 0.62 dL/g.

### Example 7a: Preparation of (E)-3-[4-[4-(4,4,4-trifluorobutoxy)benzoyl]oxyphenyl]prop-2-enoic acid

19.5 g (164.1 mmol) of thionylchloride are added by portion in 30 min to a suspension of 37.0 g (149.1 mmol) of 4-(4,4,4-trifluorobutoxy)benzoic acid in 100 mL of toluene and 0.8 mL of DMF at 70° C. After 2 hours at 75° C. the excess of thionyl chloride is distilled off under pressure. The reaction mixture is subsequently cooled down to room temperature and 18.9 g (155.1 mmol) of 4-hydroxybenzaldehyde, 0.91 g (7.5 mmol) of 4-Dimethylaminopyridine and 52.0 g (657.4 mmol) of pyridine are added. After 2 hours of agitation at room temperature, 26.53 g (254.9 mmol) of malonic acid and 7.3 g (102.6 mmol) of pyrrolidine are added and the reaction mixture is heated up to 80° C. After 4 h at 80° C., the reaction mixture is cooled down to 40° C., 150 mL of MeOH are added and the reaction mixture is cooled down to 0° C. After 1 h at 0° C., the precipitated is filtered off, washed with 100 mL of cold methanol and dry under vacuum at 40° C. to give 53.0 g (90%) of (E)-3-[4-[4-(4,4,4-trifluorobutoxy)benzoyl]oxyphenyl]prop-2-enoic acid as a white powder.

¹H NMR (300 MHz) in DMSO-D₆: 12.40 (b, 1H), 8.08 (d, 2H), 7.79 (d, 2H), 7.63 (d, 1H), 7.32 (d, 2H), 7.14 (d, 2H), 6.54 (d, 1H), 4.17 (t, 2H), 2.45 (m, 2H), 1.98 (m, 2H).

### Example 7b: Preparation of [4-[(E)-3-[2-(2,4-dinitrophenyl)ethoxy]-3-oxo-prop-1-enyl]phenyl]4-(4,4,4-trifluorobutoxy)benzoate

2.50 g (11.8 mmol) of 2-(2,4-dinitrophenyl)ethanol, 4.65 g (11.8 mmol) of (E)-3-[4-[4-(4,4,4-trifluorobutoxy)benzoyl]oxyphenyl]prop-2-enoic acid, 144 mg (1.2 mmol) of 4-Dimethylaminopyridine are dissolved in 30 ml of dichloromethane. 2.48 g (13.0 mmol) of N-(3-Dimethylaminopropyl)-N′-ethylcarbodiimide hydrochloride (EDC hydrochloride) are added at 0° C. The solution is stirred for 1 h at 0° C. and allowed to stir at room temperature overnight. After 22 hours at room temperature the reaction mixture is partitioned between dichloromethane and water. The organic phase is washed repeatedly with water, dried over sodium sulphate, filtered, and concentrated by rotary evaporation. Chromatography of the residue on silica gel using toluene:ethyl acetate 95:5 as eluant and crystallization form ethylacetate:hexane mixture to yield 5.21 g (75%) of [4-[(E)-3-[2-(2,4-dinitrophenyl)ethoxy]-3-oxo-prop-1-enyl]phenyl]4-(4,4,4-trifluorobutoxy)benzoate as colorless crystals.

¹H NMR (300 MHz) in DMSO-D₆: 8.74 (d, 1H), 8.51 (dd, 1H), 8.09 (dd, 2H), 7.93 (d, 1H), 7.80 (d, 2H), 7.65 (d, 1H), 7.34 (d, 2H), 7.14 (d, 2H), 6.55 (d, 1H), 4.47 (t, 2H), 4.17 (t, 2H), 2.45 (m, 2H), 2.00 (m, 2H).

### Example 7c: Preparation of [4-[(E)-3-[2-(2,4-diaminophenyl)ethoxy]-3-oxo-prop-1-enyl]phenyl] 4-(4,4,4-trifluorobutoxy)benzoate

4.93 g (8.38 mmol) of ([4-[(E)-3-[2-(2,4-dinitrophenyl)ethoxy]-3-oxo-prop-1-enyl]phenyl]4-(4,4,4-trifluorobutoxy)benzoate are dissolved in a mixture of 54 ml of N,N-dimethylformamide and 6 ml water. 13.9 g (51.4 mmol) ferric chloride hexahydrate are added. 5.60 g (85.7 mmol) Zinc powder are added portion wise within 60 min. The mixture is allowed to react for 2 hours. The reaction mixture is then partitioned between ethyl acetate and water and filtered. The organic phase is washed repeatedly with water, dried over sodium sulfate, filtered, and concentrated by rotary evaporation. Filtration of the residue on silica gel using toluene:ethyl acetate (1:3) as eluant and crystallization form ethylacetate:hexane mixture to yield 3.20 g (72%) of [4-[(E)-3-[2-(2,4-diaminophenyl)ethoxy]-3-oxo-prop-1-enyl]phenyl]4-(4,4,4-trifluorobutoxy)benzoate as orange powder.

¹H NMR (300 MHz) in DMSO-D₆: 8.10 (d, 2H), 7.83 (d, 2H), 7.70 (d, 1H), 7.34 (d, 2H), 7.15 (d, 2H), 6.64 (m, 1H+1H), 5.90 (m, 1H), 5.80 (m, 1H), 4.66 (m, 2H), 4.58 (m, 2H) 4.18 (m, 2H+2H), 2.70 (t, 2H), 2.47 (m, 2H), 2.01 (m, 2H).

### Example 8a: Preparation of (E)-3-[4-[4-(4-pentylcyclohexyl)cyclohexanecarbonyl]oxyphenyl]prop-2-enoic acid

11.63 g (97.74 mmol) of thionylchloride are added by portion in 30 min to a suspension of 24.92 g (88.86 mmol) of 4-(4-pentylcyclohexyl)cyclohexanecarboxylic acid in 75 mL of toluene and 0.06 mL of DMF at 75° C. After 2 hours at 75° C. the excess of thionyl chloride is distilled off under pressure. The reaction mixture is subsequently cooled down to room temperature and 11.29 g (92.41 mmol) of 4-hydroxybenzaldehyde, 0.54 g (4.44 mmol) of 4-Dimethylaminopyridine and 30.5 g (385.64 mmol) of pyridine are added. After 2 hours of agitation at room temperature, 15.81 g (151.95 mmol) of malonic acid and 3.22 g (45.32 mmol) of pyrrolidine are added and the reaction mixture is heated up to 80° C. After 4 h at 80° C., the reaction mixture is cooled down to 40° C., 150 mL of MeOH are added and the reaction mixture is cooled down to 0° C. After 1 h at 0° C., the precipitated is filtered off, washed with 100 mL of cold methanol and dry under vacuum at 40° C. to give to give 31.54 g (83%) of (E)-3-[4-[4-(4-pentylcyclohexyl)cyclohexanecarbonyl]oxyphenyl]prop-2-enoic acid as a white powder.

¹H NMR (300 MHz) in DMSO-D₆: 12.37 (b, 1H), 7.73 (d, 2H), 7.59 (d, 1H), 7.14 (d, 2H), 6.50 (d, 1H), 2.08 (m, 2H), 1.73 (m, 6H), 1.5-0.7 (m, 20H), 0.85 (t, 3H).

### Example 8b: Preparation of [4-[(E)-3-[2-(2,4-dinitrophenyl)ethoxy]-3-oxo-prop-1-enyl]phenyl]4-(4-pentylcyclohexyl)cyclohexanecarboxylate

2.50 g (11.8 mmol) of 2-(2,4-dinitrophenyl)ethanol, 5.03 g (11.8 mmol) of (E)-3-[4-[4-(4-pentylcyclohexyl)cyclohexanecarbonyl]oxyphenyl]prop-2-enoic acid, 144 mg (1.2 mmol) of 4-Dimethylaminopyridine are dissolved in 30 ml of dichloromethane. 2.48 g (13.0 mmol) of N-(3-Dimethylaminopropyl)-N′-ethylcarbodiimide hydrochloride (EDC hydrochloride) are added at 0° C. The solution is stirred for 1 h at 0° C. and allowed to stir at room temperature overnight. After 22 hours at room temperature the reaction mixture is partitioned between dichloromethane and water. The organic phase is washed repeatedly with water, dried over sodium sulphate, filtered, and concentrated by rotary evaporation. Chromatography of the residue on silica gel using toluene:ethyl acetate 95:5 as eluant and crystallization form ethylacetate:hexane mixture to yield 5.49 g (75%) of [4-[(E)-3-[2-(2,4-dinitrophenyl)ethoxy]-3-oxo-prop-1-enyl]phenyl]4-(4-pentylcyclohexyl)cyclohexanecarboxylate as colorless crystals.

¹H NMR (300 MHz) in DMSO-D₆: 8.74 (d, 1H), 8.51 (dd, 1H), 7.92 (d, 1H), 7.75 (d, 2H), 7.61 (d, 1H), 7.16 (d, 2H), 6.52 (d, 1H), 4.46 (t, 2H), 3.38 (t, 2H), 2.1 (m, 2H), 1.7 (m, 6H), 1.5-0.7 (m, 20H), 0.85 (t, 3H).

### Example 8c: Preparation of [4-[(E)-3-[2-(2,4-diaminophenyl)ethoxy]-3-oxo-prop-1-enyl]phenyl]4-(4-pentylcyclohexvl)cyclohexanecarboxylate

5.20 g (8.38 mmol) of [4-[(E)-3-[2-(2,4-dinitrophenyl)ethoxy]-3-oxo-prop-1-enyl]phenyl]4-(4-pentylcyclohexyl)cyclohexanecarboxylate are dissolved in a mixture of 54 ml of N,N-dimethylformamide and 6 ml water. 13.9 g (51.4 mmol) ferric chloride hexahydrate are added. 5.60 g (85.7 mmol) Zinc powder are added portion wise within 60 min. The mixture is allowed to react for 2 hours. The reaction mixture is then partitioned between ethyl acetate and water and filtered. The organic phase is washed repeatedly with water, dried over sodium sulfate, filtered, and concentrated by rotary evaporation. Filtration of the residue on silica gel using toluene:ethyl acetate (1:3) as eluant and crystallization form ethylacetate:hexane mixture to yield 3.06 g (65%) of [4-[(E)-3-[2-(2,4-diaminophenyl)ethoxy]-3-oxo-prop-1-enyl]phenyl]4-(4-pentylcyclohexyl)cyclohexanecarboxylate as yellow-orange powder.

¹H NMR (300 MHz) in DMSO-D₆: 7.76 (d, 2H), 7.65 (d, 1H), 7.14 (m, 2H), 6.59 (m, 1H+1H), 5.89 (m, 1H), 5.80 (m, 1H), 4.64 (s, 2H), 4.57 (s, 2H), 4.17 (t, 2H), 3.38 (t, 2H), 2.1 (m, 2H), 1.7 (m, 6H), 1.5-0.7 (m, 20H), 0.85 (t, 3H).

### Example 9: Preparation of Polyamic Acid P1

0.672 g (3.00 mmol) of 4,10-dioxatricyclo[6.3.1.0^{2,7}]dodecane-3,5,9,11-tetrone is added to a solution of 0.951 g (1.80 mmol) of [4-[(E)-3-[2-(2,4-diaminophenyl)ethoxy]-3-oxo-prop-1-enyl]phenyl]4-(4,4,4-trifluorobutoxy)benzoate, 0.336 g (0.60 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.073 g (0.60 mmol) of 2-methylbenzene-1,3-diamine in 4.741 g of NMP. Stirring is then carried out at 0° C. for 2 hours. The mixture is subsequently allowed to react for 72 hours at room temperature. Polyamic acid P1 is obtained as 30 wt % NMP-solution with an inherent viscosity [η] of 0.36 dL/g.

### Example 10: Preparation of Polyamic Acid P2

0.672 g (3.00 mmol) of 4,10-dioxatricyclo[6.3.1.0^{2,7}]dodecane-3,5,9,11-tetrone is added to a solution of 0.634 g (1.20 mmol) of [4-[(E)-3-[2-(2,4-diaminophenyl)ethoxy]-3-oxo-prop-1-enyl]phenyl]4-(4,4,4-trifluorobutoxy)benzoate, 0.673 g (1.20 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.073 g (0.60 mmol) of 2-methylbenzene-1,3-diamine in 4.790 g of NMP. Stirring is then carried out at 0° C. for 2 hours. The mixture is subsequently allowed to react for 72 hours at room temperature. Polyamic acid P2 is obtained as 30 wt % NMP-solution with an inherent viscosity [η] of 0.38 dL/g.

### Example 11: Preparation of Polyamic Acid P3

0.672 g (3.00 mmol) of 4,10-dioxatricyclo[6.3.1.0^{2,7}]dodecane-3,5,9,11-tetrone is added to a solution of 1.348 g (2.55 mmol) of [4-[(E)-3-[2-(2,4-diaminophenyl)ethoxy]-3-oxo-prop-1-enyl]phenyl]4-(4,4,4-trifluorobutoxy)benzoate, and 0.252 g (0.45 mmol) of [4-[(E)-3-[2-(2,4-diaminophenyl)ethoxy]-3-oxo-prop-1-enyl]phenyl]4-(4-pentylcyclohexyl)cyclohexanecarboxylate, in 5.302 g of NMP. Stirring is then carried out at 0° C. for 2 hours. The mixture is subsequently allowed to react for 72 hours at room temperature. Polyamic acid P3 is obtained as 30 wt % NMP-solution with an inherent viscosity [η] of 0.47 dL/g.

### Example 12: Preparation of Polyamic Acid P4

0.588 g (3.00 mmol) of 4,9-dioxatricyclo[5.3.0.0^{2,6}]decane-3,5,8,10-tetrone is added to a solution of 1.110 g (2.10 mmol) of [4-[(E)-3-[2-(2,4-diaminophenyl)ethoxy]-3-oxo-prop-1-enyl]phenyl]4-(4,4,4-trifluorobutoxy)benzoate, 0.336 g (0.60 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.037 g (0.30 mmol) of 2-methylbenzene-1,3-diamine in 4.833 g of NMP. Stirring is then carried out at 0° C. for 2 hours. The mixture is subsequently allowed to react for 72 hours at room temperature. Polyamic acid P4 is obtained as 30 wt % NMP-solution with an inherent viscosity [η] of 0.90 dL/g.

### Example 13: Preparation of Polyamic Acid P5

0.588 g (3.00 mmol) of 4,9-dioxatricyclo[5.3.0.0^{2,6}]decane-3,5,8,10-tetrone is added to a solution of 0.539 g (1.02 mmol) of [4-[(E)-3-[2-(2,4-diaminophenyl)ethoxy]-3-oxo-prop-1-enyl]phenyl]4-(4,4,4-trifluorobutoxy)benzoate, 0.555 g (0.99 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.120 g (0.99 mmol) of 2-methylbenzene-1,3-diamine in 4.208 g of NMP. Stirring is then carried out at 0° C. for 2 hours. The mixture is subsequently allowed to react for 72 hours at room temperature. Polyamic acid P5 is obtained as 30 wt % NMP-solution with an inherent viscosity [η] of 0.30 dL/g.

### Example 14: Preparation of Polyamic Acid P6

0.588 g (3.00 mmol) of 4,9-dioxatricyclo[5.3.0.0^{2,6}]decane-3,5,8,10-tetrone is added to a solution of 0.951 g (1.80 mmol) of [4-[(E)-3-[2-(2,4-diaminophenyl)ethoxy]-3-oxo-prop-1-enyl]phenyl]4-(4,4,4-trifluorobutoxy)benzoate, 0.336 g (0.60 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.120 g (0.60 mmol) of 4-(4-aminophenoxy) aniline in 4.658 g of NMP. Stirring is then carried out at 0° C. for 2 hours. The mixture is subsequently allowed to react for 72 hours at room temperature. Polyamic acid P6 is obtained as 30 wt % NMP-solution with an inherent viscosity [η] of 0.32 dL/g.

### Example 15: Preparation of Polyamic Acid P7

0.588 g (3.00 mmol) of 4,9-dioxatricyclo[5.3.0.0^{2,6}]decane-3,5,8,10-tetrone is added to a solution of 0.951 g (1.80 mmol) of [4-[(E)-3-[2-(2,4-diaminophenyl)ethoxy]-3-oxo-prop-1-enyl]phenyl]4-(4,4,4-trifluorobutoxy)benzoate, 0.336 g (0.60 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.106 g (0.60 mmol) of 5-(trifluoromethyl)benzene-1,3-diamine in 4.624 g of NMP. Stirring is then carried out at 0° C. for 2 hours. The mixture is subsequently allowed to react for 72 hours at room temperature. Polyamic acid P7 is obtained as 30 wt % NMP-solution with an inherent viscosity [η] of 0.27 dL/g.

### Example 16: Preparation of Polyamic Acid P8

0.588 g (3.00 mmol) of 4,9-dioxatricyclo[5.3.0.0^{2,6}]decane-3,5,8,10-tetrone is added to a solution of 1.110 g (2.10 mmol) of [4-[(E)-3-[2-(2,4-diaminophenyl)ethoxy]-3-oxo-prop-1-enyl]phenyl]4-(4,4,4-trifluorobutoxy)benzoate, 0.336 g (0.60 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.096 g (0.30 mmol) of 4-[4-amino-2-(trifluoromethyl)phenyl]-3-(trifluoromethyl)aniline in 4.972 g of NMP. Stirring is then carried out at 0° C. for 2 hours. The mixture is subsequently allowed to react for 72 hours at room temperature. Polyamic acid P8 is obtained as 30 wt % NMP-solution with an inherent viscosity [η] of 0.33 dL/g.

### Example 17: Preparation of Polyamic Acid P9

0.588 g (3.00 mmol) of 4,9-dioxatricyclo[5.3.0.0^{2,6}]decane-3,5,8,10-tetrone is added to a solution of 1.110 g (2.10 mmol) of [4-[(E)-3-[2-(2,4-diaminophenyl)ethoxy]-3-oxo-prop-1-enyl]phenyl]4-(4,4,4-trifluorobutoxy)benzoate, 0.252 g (0.45 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.055 g (0.45 mmol) of 2-methylbenzene-1,3-diamine in 4.680 g of NMP. Stirring is then carried out at 0° C. for 2 hours. The mixture is subsequently allowed to react for 72 hours at room temperature. Polyamic acid P9 is obtained as 30 wt % NMP-solution with an inherent viscosity [η] of 0.60 dL/g.

### Example 18: Preparation of Polyamic Acid P10

0.588 g (3.00 mmol) of 4,9-dioxatricyclo[5.3.0.0^{2,6}]decane-3,5,8,10-tetrone is added to a solution of 0.951 g (1.80 mmol) of [4-[(E)-3-[2-(2,4-diaminophenyl)ethoxy]-3-oxo-prop-1-enyl]phenyl]4-(4,4,4-trifluorobutoxy)benzoate, 0.336 g (0.60 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.073 g (0.60 mmol) of 2-methylbenzene-1,3-diamine in 4.549 g of NMP. Stirring is then carried out at 0° C. for 2 hours. The mixture is subsequently allowed to react for 72 hours at room temperature. Polyamic acid P10 is obtained as 30 wt % NMP-solution with an inherent viscosity [η] of 0.38 dL/g.

### Example 19: Preparation of Polyamic Acid P11

0.588 g (3.00 mmol) of 4,9-dioxatricyclo[5.3.0.0^{2,6}]decane-3,5,8,10-tetrone is added to a solution of 0.872 g (1.65 mmol) of [4-[(E)-3-[2-(2,4-diaminophenyl)ethoxy]-3-oxo-prop-1-enyl]phenyl]4-(4,4,4-trifluorobutoxy)benzoate, 0.336 g (0.60 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.092 g (0.75 mmol) of 2-methylbenzene-1,3-diamine in 4.406 g of NMP. Stirring is then carried out at 0° C. for 2 hours. The mixture is subsequently allowed to react for 72 hours at room temperature. Polyamic acid P11 is obtained as 30 wt % NMP-solution with an inherent viscosity [η] of 0.58 dL/g.

### Example 20: Preparation of Polyamic Acid P12

0.588 g (3.00 mmol) of 4,9-dioxatricyclo[5.3.0.0^{2,6}]decane-3,5,8,10-tetrone is added to a solution of 0.951 g (1.80 mmol) of [4-[(E)-3-[2-(2,4-diaminophenyl)ethoxy]-3-oxo-prop-1-enyl]phenyl]4-(4,4,4-trifluorobutoxy)benzoate, 0.336 g (0.60 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.192 g (0.60 mmol) of 4-[4-amino-2-(trifluoromethyl)phenyl]-3-(trifluoromethyl)aniline in 4.826 g of NMP. Stirring is then carried out at 0° C. for 2 hours. The mixture is subsequently allowed to react for 72 hours at room temperature. Polyamic acid P12 is obtained as 30 wt % NMP-solution with an inherent viscosity [η] of 0.32 dL/g.

### Example 21: Preparation of Polyamic Acid P13

0.588 g (3.00 mmol) of 4,9-dioxatricyclo[5.3.0.0^{2,6}]decane-3,5,8,10-tetrone is added to a solution of 1.031 g (1.95 mmol) of [4-[(E)-3-[2-(2,4-diaminophenyl)ethoxy]-3-oxo-prop-1-enyl]phenyl]4-(4,4,4-trifluorobutoxy)benzoate, 0.252 g (0.45 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.192 g (0.60 mmol) of 4-[4-amino-2-(trifluoromethyl)phenyl]-3-(trifluoromethyl)aniline in 4.815 g of NMP. Stirring is then carried out at 0° C. for 2 hours. The mixture is subsequently allowed to react for 72 hours at room temperature. Polyamic acid P13 is obtained as 30 wt % NMP-solution with an inherent viscosity [η] of 0.45 dL/g.

### Example 22: Preparation of Polyamic Acid P14

0.588 g (3.00 mmol) of 4,9-dioxatricyclo[5.3.0.0^{2,6}]decane-3,5,8,10-tetrone is added to a solution of 0.793 g (1.50 mmol) of [4-[(E)-3-[2-(2,4-diaminophenyl)ethoxy]-3-oxo-prop-1-enyl]phenyl]4-(4,4,4-trifluorobutoxy)benzoate, 0.336 g (0.60 mmol) of [4-[(E)-3-[2-(2,4-diaminophenyl)ethoxy]-3-oxo-prop-1-enyl]phenyl]4-(4-pentylcyclohexyl)cyclohexanecarboxylate, and 0.288 g (0.90 mmol) of 4-[4-amino-2-(trifluoromethyl)phenyl]-3-(trifluoromethyl)aniline in 4.680 g of NMP. Stirring is then carried out at 0° C. for 2 hours. The mixture is subsequently allowed to react for 72 hours at room temperature. Polyamic acid P14 is obtained as 30 wt % NMP-solution with an inherent viscosity [η] of 0.87 dL/g.

### Example 23: Preparation of Formulation 1

To a solution of 1.700 g of Polyamic acid PX3 and 0.200 g of Polyamic acid P1 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 1.

### Example 24: Preparation of Formulation 2

To a solution of 1.910 g of Polyamic acid PX1 and 0.225 g of Polyamic acid P1 are added 0.700 g of NMP, 2.390 g of GBL, 3.82 g of DEE and 0.955 g of EEP. The mixture is stirred for 30 minutes and filtrated on 0.2 μm PTFE-filter to give Formulation 2.

### Example 25: Preparation of Formulation 3

To a solution of 1.700 g of Polyamic acid PX3 and 0.200 g of Polyamic acid P2 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 3.

### Example 26: Preparation of Formulation 4

To a solution of 1.910 g of Polyamic acid PX1 and 0.225 g of Polyamic acid P2 are added 0.700 g of NMP, 2.390 g of GBL, 3.82 g of DEE and 0.955 g of EEP. The mixture is stirred for 30 minutes and filtrated on 0.2 μm PTFE-filter to give Formulation 4.

### Example 27: Preparation of Formulation 5

To a solution of 1.700 g of Polyamic acid PX3 and 0.200 g of Polyamic acid P3 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 5.

### Example 28: Preparation of Formulation 6

To a solution of 1.910 g of Polyamic acid PX1 and 0.225 g of Polyamic acid P3 are added 0.700 g of NMP, 2.390 g of GBL, 3.82 g of DEE and 0.955 g of EEP. The mixture is stirred for 30 minutes and filtrated on 0.2 μm PTFE-filter to give Formulation 6.

### Example 29: Preparation of Formulation 7

To a solution of 1.700 g of Polyamic acid PX3 and 0.200 g of Polyamic acid P4 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 8.

### Example 30: Preparation of Formulation 8

To a solution of 1.700 g of Polyamic acid PX5 and 0.200 g of Polyamic acid P4 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 3.

### Example 31: Preparation of Formulation 9

To a solution of 1.910 g of Polyamic acid PX2 and 0.225 g of Polyamic acid P4 are added 0.700 g of NMP, 2.390 g of GBL, 3.82 g of DEE and 0.955 g of EEP. The mixture is stirred for 30 minutes and filtrated on 0.2 μm PTFE-filter to give Formulation 9.

### Example 32: Preparation of Formulation 10

To a solution of 1.700 g of Polyamic acid PX4 and 0.200 g of Polyamic acid P4 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 10.

### Example 33: Preparation of Formulation 11

To a solution of 1.910 g of Polyamic acid PX1 and 0.225 g of Polyamic acid P5 are added 0.700 g of NMP, 2.390 g of GBL, 3.82 g of DEE and 0.955 g of EEP. The mixture is stirred for 30 minutes and filtrated on 0.2 μm PTFE-filter to give Formulation 11.

### Example 34: Preparation of Formulation 12

To a solution of 1.910 g of Polyamic acid PX1 and 0.225 g of Polyamic acid P6 are added 0.700 g of NMP, 2.390 g of GBL, 3.82 g of DEE and 0.955 g of EEP. The mixture is stirred for 30 minutes and filtrated on 0.2 μm PTFE-filter to give Formulation 12.

### Example 35: Preparation of Formulation 13

To a solution of 1.700 g of Polyamic acid PX3 and 0.200 g of Polyamic acid P7 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 13.

### Example 36: Preparation of Formulation 14

To a solution of 1.910 g of Polyamic acid PX1 and 0.225 g of Polyamic acid P7 are added 0.700 g of NMP, 2.390 g of GBL, 3.82 g of DEE and 0.955 g of EEP. The mixture is stirred for 30 minutes and filtrated on 0.2 μm PTFE-filter to give Formulation 14.

### Example 37: Preparation of Formulation 15

To a solution of 1.700 g of Polyamic acid PX3 and 0.200 g of Polyamic acid P8 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 15.

### Example 38: Preparation of Formulation 16

To a solution of 1.910 g of Polyamic acid PX1 and 0.225 g of Polyamic acid P8 are added 0.700 g of NMP, 2.390 g of GBL, 3.82 g of DEE and 0.955 g of EEP. The mixture is stirred for 30 minutes and filtrated on 0.2 μm PTFE-filter to give Formulation 16.

### Example 39: Preparation of Formulation 17

To a solution of 1.700 g of Polyamic acid PX3 and 0.200 g of Polyamic acid P9 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 17.

### Example 40: Preparation of Formulation 18

To a solution of 1.910 g of Polyamic acid PX1 and 0.225 g of Polyamic acid P9 are added 0.700 g of NMP, 2.390 g of GBL, 3.82 g of DEE and 0.955 g of EEP. The mixture is stirred for 30 minutes and filtrated on 0.2 μm PTFE-filter to give Formulation 18.

### Example 41: Preparation of Formulation 19

To a solution of 1.700 g of Polyamic acid PX3 and 0.200 g of Polyamic acid P10 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 19.

### Example 42: Preparation of Formulation 20

To a solution of 1.910 g of Polyamic acid PX1 and 0.225 g of Polyamic acid P10 are added 0.700 g of NMP, 2.390 g of GBL, 3.82 g of DEE and 0.955 g of EEP. The mixture is stirred for 30 minutes and filtrated on 0.2 μm PTFE-filter to give Formulation 20.

### Example 43: Preparation of Formulation 21

To a solution of 1.700 g of Polyamic acid PX3 and 0.200 g of Polyamic acid P11 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 21.

### Example 44: Preparation of Formulation 22

To a solution of 1.910 g of Polyamic acid PX1 and 0.225 g of Polyamic acid P11 are added 0.700 g of NMP, 2.390 g of GBL, 3.82 g of DEE and 0.955 g of EEP. The mixture is stirred for 30 minutes and filtrated on 0.2 μm PTFE-filter to give Formulation 22.

### Example 45: Preparation of Formulation 23

To a solution of 1.700 g of Polyamic acid PX3 and 0.200 g of Polyamic acid P12 are added 0.900 g of NMP, 2.400 g of GBL, 3.840 g of DEE and 0.960 g of IBIB. The mixture is stirred for 30 minutes and filtrated on 0.2 μm PTFE-filter to give Formulation 23.

### Example 46: Preparation of Formulation 24

To a solution of 1.910 g of Polyamic acid PX1 and 0.225 g of Polyamic acid P12 are added 0.700 g of NMP, 2.390 g of GBL, 3.82 g of DEE and 0.955 g of EEP. The mixture is stirred for 30 minutes and filtrated on 0.2 μm PTFE-filter to give Formulation 24.

### Example 47: Preparation of Formulation 25

To a solution of 1.910 g of Polyamic acid PX1 and 0.225 g of Polyamic acid P13 are added 0.700 g of NMP, 2.390 g of GBL, 3.82 g of DEE and 0.955 g of EEP. The mixture is stirred for 30 minutes and filtrated on 0.2 μm PTFE-filter to give Formulation 25.

### Example 48: Preparation of Formulation 26

To a solution of 1.910 g of Polyamic acid PX1 and 0.225 g of Polyamic acid P14 are added 0.700 g of NMP, 2.390 g of GBL, 3.82 g of DEE and 0.955 g of EEP. The mixture is stirred for 30 minutes and filtrated on 0.2 μm PTFE-filter to give Formulation 26.

### APPLICATION EXAMPLES

Measurement of the pretilt angle as used in the examples: To measure the pretilt angle a rotating analyzer is used, as described by Michio Kitamura, Shunsuke Kobayashi and Katsumi Mori; Journal of the SID14/5, 2006; p509-p514.”

### Example 1

Formulation 1 is spin-coated onto two ITO coated glass substrates at a spin speed of c.a. 2000 rpm for 30 seconds. After spin-coating, the substrates are subjected to a baking procedure consisting of pre-baking for 90 seconds at 80° C. and post-baking for 40 minutes at 200° C. Then, the substrates are exposed to linearly polarized light at an incidence angle of 40° relative to the normal of the substrate surface (22 mJ·cm²-PLUMBOL). The plane of polarization is parallel to the substrate's longest edges. The cells are assembled with the 2 substrates, the exposed polymer layers facing the inside of the cell. The substrates are adjusted relative to each other such that the induced alignment directions are parallel to each other. The cells are capillary filled with liquid crystal MLC-6610 (Merck KGA-Δε<0). Finally, the filled cells are further subjected to a thermal annealing at 130° C. for 10 minutes, thereby completing the cell process. The liquid crystal in the cell showed well defined and homogeneous vertical orientation before and after thermal annealing of the cell. A pretilt angle of 87.88° is measured.

### Example 2

A cell is prepared as in Example 1, except that formulation 2 is coated. The liquid crystal in the cell showed well defined and homogeneous vertical orientation before and after thermal annealing of the cell. A pretilt angle of 88.01° is measured.

### Example 3

A cell is prepared as in Example 1, except that formulation 3 is coated. The liquid crystal in the cell showed well defined and homogeneous vertical orientation before and after thermal annealing of the cell. A pretilt angle of 88.18° is measured.

### Example 4

A cell is prepared as in Example 1, except that formulation 4 is coated. The liquid crystal in the cell showed well defined and homogeneous vertical orientation before and after thermal annealing of the cell. A pretilt angle of 88.29° is measured.

### Example 5

A cell is prepared as in Example 1, except that formulation 5 is coated. The liquid crystal in the cell showed well defined and homogeneous vertical orientation before and after thermal annealing of the cell. A pretilt angle of 88.22° is measured.

### Example 6

A cell is prepared as in Example 1, except that formulation 6 is coated. The liquid crystal in the cell showed well defined and homogeneous vertical orientation before and after thermal annealing of the cell. A pretilt angle of 88.25° is measured.

### Example 7

A cell is prepared as in Example 1, except that formulation 7 is coated. The liquid crystal in the cell showed well defined and homogeneous vertical orientation before and after thermal annealing of the cell. A pretilt angle of 87.03° is measured.

### Example 8

A cell is prepared as in Example 1, except that formulation 8 is coated. The liquid crystal in the cell showed well defined and homogeneous vertical orientation before and after thermal annealing of the cell. A pretilt angle of 87.16° is measured.

### Example 9

A cell is prepared as in Example 1, except that formulation 9 is coated. The liquid crystal in the cell showed well defined and homogeneous vertical orientation before and after thermal annealing of the cell. A pretilt angle of 87.13° is measured.

### Example 10

A cell is prepared as in Example 1, except that formulation 10 is coated. The liquid crystal in the cell showed well defined and homogeneous vertical orientation before and after thermal annealing of the cell. A pretilt angle of 87.26° is measured.

### Example 11

A cell is prepared as in Example 1, except that formulation 11 is coated. The liquid crystal in the cell showed well defined and homogeneous vertical orientation before and after thermal annealing of the cell. A pretilt angle of 87.23° is measured.

### Example 12

A cell is prepared as in Example 1, except that formulation 12 is coated. The liquid crystal in the cell showed well defined and homogeneous vertical orientation before and after thermal annealing of the cell. A pretilt angle of 87.32° is measured.

### Example 13

A cell is prepared as in Example 1, except that formulation 13 is coated. The liquid crystal in the cell showed well defined and homogeneous vertical orientation before and after thermal annealing of the cell. A pretilt angle of 87.05° is measured.

### Example 14

A cell is prepared as in Example 1, except that formulation 14 is coated. The liquid crystal in the cell showed well defined and homogeneous vertical orientation before and after thermal annealing of the cell. A pretilt angle of 87.23° is measured.

### Example 15

A cell is prepared as in Example 1, except that formulation 15 is coated. The liquid crystal in the cell showed well defined and homogeneous vertical orientation before and after thermal annealing of the cell. A pretilt angle of 87.09° is measured.

### Example 16

A cell is prepared as in Example 1, except that formulation 16 is coated. The liquid crystal in the cell showed well defined and homogeneous vertical orientation before and after thermal annealing of the cell. A pretilt angle of 87.23° is measured.

### Example 17

A cell is prepared as in Example 1, except that formulation 17 is coated. The liquid crystal in the cell showed well defined and homogeneous vertical orientation before and after thermal annealing of the cell. A pretilt angle of 86.72° is measured.

### Example 18

A cell is prepared as in Example 1, except that formulation 18 is coated. The liquid crystal in the cell showed well defined and homogeneous vertical orientation before and after thermal annealing of the cell. A pretilt angle of 86.91° is measured.

### Example 19

A cell is prepared as in Example 1, except that formulation 19 is coated. The liquid crystal in the cell showed well defined and homogeneous vertical orientation before and after thermal annealing of the cell. A pretilt angle of 86.69° is measured.

### Example 20

A cell is prepared as in Example 1, except that formulation 20 is coated. The liquid crystal in the cell showed well defined and homogeneous vertical orientation before and after thermal annealing of the cell. A pretilt angle of 86.94° is measured.

### Example 21

A cell is prepared as in Example 1, except that formulation 21 is coated. The liquid crystal in the cell showed well defined and homogeneous vertical orientation before and after thermal annealing of the cell. A pretilt angle of 86.62° is measured.

### Example 22

A cell is prepared as in Example 1, except that formulation 22 is coated. The liquid crystal in the cell showed well defined and homogeneous vertical orientation before and after thermal annealing of the cell. A pretilt angle of 86.90° is measured.

### Example 23

A cell is prepared as in Example 1, except that formulation 23 is coated. The liquid crystal in the cell showed well defined and homogeneous vertical orientation before and after thermal annealing of the cell. A pretilt angle of 86.74° is measured.

### Example 24

A cell is prepared as in Example 1, except that formulation 24 is coated. The liquid crystal in the cell showed well defined and homogeneous vertical orientation before and after thermal annealing of the cell. A pretilt angle of 87.02° is measured.

### Example 25

A cell is prepared as in Example 1, except that formulation 25 is coated. The liquid crystal in the cell showed well defined and homogeneous vertical orientation before and after thermal annealing of the cell. A pretilt angle of 86.55° is measured.

### Example 26

A cell is prepared as in Example 1, except that formulation 26 is coated. The liquid crystal in the cell showed well defined and homogeneous vertical orientation before and after thermal annealing of the cell. A pretilt angle of 86.37° is measured.

### Example 27

Voltage holding ratio (VHR) of the cells is measured at 60° C. using LCM-1 instrument from Toyo, Japan. The VHR was measured using a short and a long frame period (T). In the short one, the voltage decay V (at T=16.67 ms) of a voltage surge of 64 μs with V₀(V at t=0)=1V is then measured over a period of T=16.67 ms. The voltage holding ratio is then determined, at room temperature, given by integration of the measurement curve between V₀ and V weighted by the area in the case of 100% VHR. The table below shows VHR measured for all tested cells. The results show VHR >99% for all tested cells.

| Cell | Alignment quality | VHR |
|---|---|---|
| Example 8 | Good | 99.6% |
| Example 9 | Good | 99.7% |
| Example 10 | Good | 99.5% |
| Example 11 | Good | 99.5% |
| Example 16 | Good | 99.7% |
| Example 21 | Good | 99.7% |
| Example 22 | Good | 99.7% |
| Example 24 | Good | 99.5% |

### Example 28: Determination of AC Memory (ACM)

An AC-voltage of 60 Hz frequency and 7.5 V amplitude is applied to cells prepared examples 1 to 25. After 48 hours of stress, the cells are short-circuited, and the change of the pre-tilt angle is measured after 60 min of relaxation. The difference in pretilt measurement between before and after the stress-relaxation cycle gives AC-Memory (ACM°). If ACM° is excellent below −0.015°, very good between −0.016° and −0.030°, good between −0.031° and −0.045°, medium between −0.046° and −0.060° and bad for value higher than −0.061°.

| Cell | ACM [°] | Cell | ACM [°] |
|---|---|---|---|
| Example 1 | excellent | Example 2 | excellent |
| Example 3 | excellent | Example 4 | excellent |
| Example 5 | excellent | Example 6 | excellent |
| Example 7 | very good | Example 8 | excellent |
| Example 9 | very good | Example 10 | excellent |
| Example 11 | very good | Example 12 | very good |
| Example 13 | very good | Example 14 | very good |
| Example 15 | very good | Example 16 | very good |
| Example 17 | very good | Example 18 | very good |
| Example 19 | very good | Example 20 | very good |
| Example 21 | good | Example 22 | very good |
| Example 23 | very good | Example 24 | very good |
| Example 25 | good | Example 26 | medium |

### Examples Part 2

### Example 49: Preparation of Polyamic Acid P15

0.672 g (3.00 mmol) of 4,10-dioxatricyclo[6.3.1.0^{2,7}]dodecane-3,5,9,11-tetrone is added to a solution of 1.268 g (2.40 mmol) of [4-[(E)-3-[2-(2,4-diaminophenyl)ethoxy]-3-oxo-prop-1-enyl]phenyl]4-(4,4,4-trifluorobutoxy)benzoate, and 0.336 g (0.60 mmol) of [4-[(E)-3-[2-(2,4-diaminophenyl)ethoxy]-3-oxo-prop-1-enyl]phenyl]4-4 pentylcyclohexyl)cyclohexanecarboxylate, in 5.311 g of NMP. Stirring is then carried out at 0° C. for 2 hours. The mixture is subsequently allowed to react for 72 hours at room temperature. Polyamic acid P15 is obtained as 30 wt % NMP-solution with an inherent viscosity [η] of 0.47 dL/g.

### Example 50: Preparation of [4-[(E)-3-[2-(2,4-diaminophenyl)ethoxy]-3-oxo-prop-1-enyl]phenyl]4-pentylcyclohexanecarboxylate

[4-[(E)-3-[2-(2,4-diaminophenyl)ethoxy]-3-oxo-prop-1-enyl]phenyl]4-pentylcyclohexanecarboxylate is prepared following the three steps described in example 8a, 8b and 8c but starting from 4-pentylcyclohexanecarboxylic acid instead 4-(4-pentylcyclohexyl)cyclohexanecarboxylic acid

¹H NMR (300 MHz) in DMSO-D₆: 7.77 (d, 2H), 7.65 (d, 1H), 7.15 (d, 2H), 6.60 (m, 1H+1H), 5.89 (d, 1H), 5.79 (dd, 1H), 4.64 (s, 2H), 4.58 (s, 2H), 4.17 (t, 2H), 3.38 (t, 2H), 2.68 (t, 2H), 2.50 (m, 1H), 2.06 (m, 2H), 1.65 (m, 2H), 1.6-0.8 (m, 13H), 0.86 (t, 3H).

### Example 51: Preparation of Polyamic Acid P16

0.672 g (3.00 mmol) of 4,10-dioxatricyclo[6.3.1.0^{2,7}]dodecane-3,5,9,11-tetrone is added to a solution of 1.268 g (2.40 mmol) of [4-[(E)-3-[2-(2,4-diaminophenyl)ethoxy]-3-oxo-prop-1-enyl]phenyl]4-(4,4,4-trifluorobutoxy)benzoate, and 0.287 g (0.60 mmol) of [4-[(E)-3-[2-(2,4-diaminophenyl)ethoxy]-3-oxo-prop-1-enyl]phenyl]4-pentylcyclohexanecarboxylate, in 5.196 g of NMP. Stirring is then carried out at 0° C. for 2 hours. The mixture is subsequently allowed to react for 72 hours at room temperature. Polyamic acid P16 is obtained as 30 wt % NMP-solution with an inherent viscosity [η] of 0.63 dL/g.

### Example 52: Preparation of Polyamic Acid P17

0.672 g (3.00 mmol) of 4,10-dioxatricyclo[6.3.1.0^{2,7}]dodecane-3,5,9,11-tetrone is added to a solution of 1.189 g (2.25 mmol) of [4-[(E)-3-[2-(2,4-diaminophenyl)ethoxy]-3-oxo-prop-1-enyl]phenyl]4-(4,4,4-trifluorobutoxy)benzoate, and 0.359 g (0.75 mmol) of [4-[(E)-3-[2-(2,4-diaminophenyl)ethoxy]-3-oxo-prop-1-enyl]phenyl]4-pentylcyclohexanecarboxylate, in 5.180 g of NMP. Stirring is then carried out at 0° C. for 2 hours. The mixture is subsequently allowed to react for 72 hours at room temperature. Polyamic acid P17 is obtained as 30 wt % NMP-solution with an inherent viscosity [η] of 0.34 dL/g.

### Example 53: Preparation of [4-[(E)-3-[2-(2,4-diaminophenyl)ethoxy]-3-oxo-prop-1-enyl]-2-methoxy-phenyl] 4-(4-pentylcyclohexvl)cyclohexanecarboxylate

[4-[(E)-3-[2-(2,4-diaminophenyl)ethoxy]-3-oxo-prop-1-enyl]-2-methoxy-phenyl]4-(4-pentylcyclohexyl)cyclohexanecarboxylate is prepared following the 3 steps described in example 8a, 8b and 8c but starting from 4-hydroxy-3-methoxy-benzaldehyde instead 4-hydroxybenzaldehyde

¹H NMR (300 MHz) in DMSO-D₆: 7.63 (d, 1H), 7.50 (d, 1H), 7.27 (m, 1H), 7.08 (m, 1H), 6.66 (m, 1H), 6.62 (m, 1H), 5.90 (m, 1H), 5.78 (m, 1H), 4.62 (m, 4H), 4.18 (t, 2H), 3.80 (s, 3H), 2.68 (m, 2H), 2.5 (m, 2H), 2.1 (m, 2H), 1.7 (m, 6H), 1.5-0.7 (m, 16H), 0.85 (t, 3H).

### Example 54: Preparation of Polyamic Acid P18

0.588 g (3.00 mmol) of 4,9-dioxatricyclo[5.3.0.0^{2,6}]decane-3,5,8,10-tetrone is added to a solution of 1.268 g (2.4 mmol) of [4-[(E)-3-[2-(2,4-diaminophenyl)ethoxy]-3-oxo-prop-1-enyl]phenyl]4-(4,4,4-trifluorobutoxy)benzoate, and 0.354 g (0.6 mmol) of [4-[(E)-3-[2-(2,4-diaminophenyl)ethoxy]-3-oxo-prop-1-enyl]-2-methoxy-phenyl]4-(4-pentylcyclohexyl)cyclohexanecarboxylate, in 5.156 g of NMP. Stirring is then carried out at 0° C. for 2 hours. The mixture is subsequently allowed to react for 72 hours at room temperature. Polyamic acid P18 is obtained as 30 wt % NMP-solution with an inherent viscosity [η] of 0.84 dL/g.

### Example 55: Preparation of Polyamic Acid P19

0.588 g (3.00 mmol) of 4,9-dioxatricyclo[5.3.0.0^{2,6}]decane-3,5,8,10-tetrone is added to a solution of 0.951 g (1.8 mmol) of [4-[(E)-3-[2-(2,4-diaminophenyl)ethoxy]-3-oxo-prop-1-enyl]phenyl]4-(4,4,4-trifluorobutoxy)benzoate, 0.354 g (0.6 mmol) of [4-[(E)-3-[2-(2,4-diaminophenyl)ethoxy]-3-oxo-prop-1-enyl]-2-methoxy-phenyl]4-(4-pentylcyclohexyl)cyclohexanecarboxylate, and 0.073 g (0.6 mmol) of 2-methylbenzene-1,3-diamine in 4.587 g of NMP. Stirring is then carried out at 0° C. for 2 hours. The mixture is subsequently allowed to react for 72 hours at room temperature. Polyamic acid P19 is obtained as 30 wt % NMP-solution with an inherent viscosity [η] of 0.42 dL/g.

### Example 56: Preparation of Polyamic Acid P20

0.588 g (3.00 mmol) of 4,9-dioxatricyclo[5.3.0.0^{2,6}]decane-3,5,8,10-tetrone is added to a solution of 1110.0 g (2.1 mmol) of [4-[(E)-3-[2-(2,4-diaminophenyl)ethoxy]-3-oxo-prop-1-enyl]phenyl]4-(4,4,4-trifluorobutoxy)benzoate, 0.355 g (0.6 mmol) of [4-[(E)-3-[2-(2,4-diaminophenyl)ethoxy]-3-oxo-prop-1-enyl]-2-methoxy-phenyl]4-(4-pentylcyclohexyl)cyclohexanecarboxylate, and 0.037 g (0.3 mmol) of 2-methylbenzene-1,3-diamine in 4.876 g of NMP. Stirring is then carried out at 0° C. for 2 hours. The mixture is subsequently allowed to react for 72 hours at room temperature. Polyamic acid P20 is obtained as 30 wt % NMP-solution with an inherent viscosity [η] of 0.61 dL/g.

### Example 57: Preparation of Polyamic Acid P21

0.672 g (3.00 mmol) of 4,10-dioxatricyclo[6.3.1.0^{2,7}]dodecane-3,5,9,11-tetrone is added to a solution of 0.673 g (1.2 mmol) [4-[(E)-3-[2-(2,4-diaminophenyl)ethoxy]-3-oxo-prop-1-enyl]phenyl]4-(4-pentylcyclohexyl)cyclohexanecarboxylate, and 0.576 g (1.8 mmol) of 4-[4-amino-2-(trifluoromethyl)phenyl]-3-(trifluoromethyl)aniline, in 4.482 g of NMP. Stirring is then carried out at 0° C. for 2 hours. The mixture is subsequently allowed to react for 72 hours at room temperature. Polyamic acid P21 is obtained as 30 wt % NMP-solution with an inherent viscosity [η] of 0.53 dL/g.

### Example 58: Preparation of Polyamic Acid P22

0.672 g (3.00 mmol) of 4,10-dioxatricyclo[6.3.1.0^{2,7}]dodecane-3,5,9,11-tetrone is added to a solution of 1.178 g (2.1 mmol) [4-[(E)-3-[2-(2,4-diaminophenyl)ethoxy]-3-oxo-prop-1-enyl]phenyl]4-(4-pentylcyclohexyl)cyclohexanecarboxylate, and 0.288 g (0.9 mmol) of 4-[4-amino-2-(trifluoromethyl)phenyl]-3-(trifluoromethyl)aniline, in 4.989 g of NMP. Stirring is then carried out at 0° C. for 2 hours. The mixture is subsequently allowed to react for 72 hours at room temperature. Polyamic acid P22 is obtained as 30 wt % NMP-solution with an inherent viscosity [η] of 0.53 dL/g.

### Example 59: Preparation of Polyamic Acid P23

0.588 g (3.00 mmol) of 4,9-dioxatricyclo[5.3.0.0^{2,6}]decane-3,5,8,10-tetrone is added to a solution of 0.841 g (1.5 mmol) [4-[(E)-3-[2-(2,4-diaminophenyl)ethoxy]-3-oxo-prop-1-enyl]phenyl]4-(4-pentylcyclohexyl)cyclohexanecarboxylate, and 0.480 g (1.5 mmol) of 4-[4-amino-2-(trifluoromethyl)phenyl]-3-(trifluoromethyl)aniline, in 4.454 g of NMP. Stirring is then carried out at 0° C. for 2 hours. The mixture is subsequently allowed to react for 72 hours at room temperature. Polyamic acid P23 is obtained as 30 wt % NMP-solution with an inherent viscosity [η] of 0.52 dL/g.

### Example 60: Preparation of Polyamic Acid P24

0.588 g (3.00 mmol) of 4,9-dioxatricyclo[5.3.0.0^{2,6}]decane-3,5,8,10-tetrone is added to a solution of 0.757 g (1.35 mmol) [4-[(E)-3-[2-(2,4-diaminophenyl)ethoxy]-3-oxo-prop-1-enyl]phenyl]4-(4-pentylcyclohexyl)cyclohexanecarboxylate, and 0.350 g (1.65 mmol) of 4-(4-amino-2-methyl-phenyl)-3-methyl-aniline, in 3.955 g of NMP. Stirring is then carried out at 0° C. for 2 hours. The mixture is subsequently allowed to react for 72 hours at room temperature. Polyamic acid P24 is obtained as 30 wt % NMP-solution with an inherent viscosity [η] of 0.55 dL/g.

### Example 61: Preparation of Polyamic Acid P25

0.588 g (3.00 mmol) of 4,9-dioxatricyclo[5.3.0.0^{2,6}]decane-3,5,8,10-tetrone is added to a solution of 0.757 g (1.35 mmol) [4-[(E)-3-[2-(2,4-diaminophenyl)ethoxy]-3-oxo-prop-1-enyl]phenyl]4-(4-pentylcyclohexyl)cyclohexanecarboxylate, and 0.330 g (1.65 mmol) of 4-(4-aminophenoxy)aniline, in 3.908 g of NMP. Stirring is then carried out at 0° C. for 2 hours. The mixture is subsequently allowed to react for 72 hours at room temperature. Polyamic acid P25 is obtained as 30 wt % NMP-solution with an inherent viscosity [η] of 0.65 dL/g.

### Example 62 Preparation of polyamic acid P26

0.588 g (3.00 mmol) of 4,9-dioxatricyclo[5.3.0.0^{2,6}]decane-3,5,8,10-tetrone is added to a solution of 1.346 g (2.4 mmol) [4-[(E)-3-[2-(2,4-diaminophenyl)ethoxy]-3-oxo-prop-1-enyl]phenyl]4-(4-pentylcyclohexyl)cyclohexanecarboxylate, and 0.192 g (0.6 mmol) of 4-[4-amino-2-(trifluoromethyl)phenyl]-3-(trifluoromethyl)aniline, in 4.961 g of NMP. Stirring is then carried out at 0° C. for 2 hours. The mixture is subsequently allowed to react for 72 hours at room temperature. Polyamic acid P26 is obtained as 30 wt % NMP-solution with an inherent viscosity [η] of 0.72 dL/g.

### Example 63: Preparation of Polyamic Acid P27

0.588 g (3.00 mmol) of 4,9-dioxatricyclo[5.3.0.0^{2,6}]decane-3,5,8,10-tetrone is added to a solution of 1.110 g (2.1 mmol) of [4-[(E)-3-[2-(2,4-diaminophenyl)ethoxy]-3-oxo-prop-1-enyl]phenyl]4-(4,4,4-trifluorobutoxy)benzoate, 0.287 g (0.6 mmol) of [4-[(E)-3-[2-(2,4-diaminophenyl)ethoxy]-3-oxo-prop-1-enyl]phenyl]4-pentylcyclohexanecarboxylate, and 0.037 g (0.3 mmol) of 2-methylbenzene-1,3-diamine in 4.208 g of NMP. Stirring is then carried out at 0° C. for 2 hours. The mixture is subsequently allowed to react for 72 hours at room temperature. Polyamic acid P27 is obtained as 30 wt % NMP-solution with an inherent viscosity [η] of 0.61 dL/g.

### Example 64: Preparation of [4-[(E)-3-[2-(2,4-diaminophenyl)ethoxy]-3-oxo-prop-1-enyl]phenyl]4-(4-ethylcyclohexyl)cyclohexanecarboxylate

[4-[(E)-3-[2-(2,4-diaminophenyl)ethoxy]-3-oxo-prop-1-enyl]phenyl]4-(4-ethylcyclohexyl)cyclohexanecarboxylate is prepared following the three steps described in example 8a, 8b and 8c but starting from 4-(4-ethylcyclohexyl)cyclohexanecarboxylic acid instead 4-(4-pentylcyclohexyl)cyclohexanecarboxylic acid

¹H NMR (300 MHz) in THF-D⁸: 7.62 (m, 1+2H), 7.11 (d, 2H), 6.64 (d, 1H), 6.49 (d, 1H), 5.88 (m, 1H+1H), 4.27 (s broad, 4H), 4.21 (t, 2H), 2.73 (t, 2H), 2.46 (m, 2H), 2.14 (m, 2H), 1.79 (m, 4H), 1.50 (m, 2H), 1.4-0.9 (m, 12H), 0.88 (t, 3H).

### Example 65: Preparation of Polyamic Acid P28

0.672 g (3.00 mmol) of 4,10-dioxatricyclo[6.3.1.0^{2,7}]dodecane-3,5,9,11-tetrone is added to a solution of 1.348 g (2.55 mmol) of [4-[(E)-3-[2-(2,4-diaminophenyl)ethoxy]-3-oxo-prop-1-enyl]phenyl]4-(4,4,4-trifluorobutoxy)benzoate, and 0.233 g (0.45 mmol) of [4-[(E)-3-[2-(2,4-diaminophenyl)ethoxy]-3-oxo-prop-1-enyl]phenyl]4-(4-ethylcyclohexyl)cyclohexanecarboxylate, in 5.257 g of NMP. Stirring is then carried out at 0° C. for 2 hours. The mixture is subsequently allowed to react for 72 hours at room temperature. Polyamic acid P28 is obtained as 30 wt % NMP-solution with an inherent viscosity [η] of 0.30 dL/g.

### Example 66: Preparation of [4-(4-pentylcyclohexyl)cyclohexyl] 4-[(E)-3-[2-(2,4-diaminophenyl)ethoxy]-3-oxo-prop-1-enyl]benzoate

[4-(4-pentylcyclohexyl)cyclohexyl]4-[(E)-3-[2-(2,4-diaminophenyl)ethoxy]-3-oxo-prop-1-enyl]benzoate is prepared following the 2 steps described in examples 8b and 8c but starting from E)-3-[4-[4-(4-pentylcyclohexyl)cyclohexoxy]carbonylphenyl]prop-2-enoic acid instead (E)-3-[4-[4-(4-pentylcyclohexyl)cyclohexanecarbonyl]oxyphenyl]prop-2-enoic acid

¹H NMR (300 MHz) in THF-D⁸: 8.01 (d, 2H), 7.71 (m, 2H+1H), 6.64 (m, 1H+1H), 5.88 (m, 1H+1H), 4.85 (m, 1H), 4.26 (t, 2H), 4.20 (s broad, 4H), 2.74 (t, 2H), 2.12 (m, 2H), 1.7 (m, 6H), 1.9-0.8 (m, 22H), 0.85 (t, 3H).

### Example 67: Preparation of Polyamic Acid P29

0.672 g (3.00 mmol) of 4,10-dioxatricyclo[6.3.1.0^{2,7}]dodecane-3,5,9,11-tetrone is added to a solution of 1.348 g (2.55 mmol) of [4-[(E)-3-[2-(2,4-diaminophenyl)ethoxy]-3-oxo-prop-1-enyl]phenyl]4-(4,4,4-trifluorobutoxy)benzoate, and 0.252 g (0.45 mmol) of [4-(4-pentylcyclohexyl)cyclohexyl]4-[(E)-3-[2-(2,4-diaminophenyl)ethoxy]-3-oxo-prop-1-enyl]benzoate, in 5.301 g of NMP. Stirring is then carried out at 0° C. for 2 hours. The mixture is subsequently allowed to react for 72 hours at room temperature. Polyamic acid P29 is obtained as 30 wt % NMP-solution with an inherent viscosity [η] of 0.31 dL/g.

### Example 68: Preparation of Polyamic Acid P30

0.672 g (3.00 mmol) of 4,10-dioxatricyclo[6.3.1.0^{2,7}]dodecane-3,5,9,11-tetrone is added to a solution of 1.682 g (3.00 mmol) of [4-[(E)-3-[2-(2,4-diaminophenyl)ethoxy]-3-oxo-prop-1-enyl]phenyl]4-(4-pentylcyclohexyl)cyclohexanecarboxylate, in 5.495 g of NMP. Stirring is then carried out at 0° C. for 2 hours. The mixture is subsequently allowed to react for 72 hours at room temperature. Polyamic acid P30 is obtained as 30 wt % NMP-solution with an inherent viscosity [η] of 0.29 dL/g.

### Example 69: Preparation of Polyamic Acid P31

0.588 g (3.00 mmol) of 4,9-dioxatricyclo[5.3.0.0^{2,6}]decane-3,5,8,10-tetrone is added to a solution of 1.682 g (3.00 mmol) of [4-[(E)-3-[2-(2,4-diaminophenyl)ethoxy]-3-oxo-prop-1-enyl]phenyl]4-(4-pentylcyclohexyl)cyclohexanecarboxylate, in 5.296 g of NMP. Stirring is then carried out at 0° C. for 2 hours. The mixture is subsequently allowed to react for 72 hours at room temperature. Polyamic acid P31 is obtained as 30 wt % NMP-solution with an inherent viscosity [η] of 0.30 dL/g.

### Example 70: Preparation of Polyamic Acid P32

0.672 g (3.00 mmol) of 4,10-dioxatricyclo[6.3.1.0^{2,7}]dodecane-3,5,9,11-tetrone is added to a solution of 1.436 g (3.00 mmol) of [4-[(E)-3-[2-(2,4-diaminophenyl)ethoxy]-3-oxo-prop-1-enyl]phenyl]4-pentylcyclohexanecarboxylate, in 4.919 g of NMP. Stirring is then carried out at 0° C. for 2 hours. The mixture is subsequently allowed to react for 72 hours at room temperature. Polyamic acid P32 is obtained as 30 wt % NMP-solution with an inherent viscosity [η] of 0.29 dL/g.

### Example 71: Preparation of Polyamic Acid P33

0.588 g (3.00 mmol) of 4,9-dioxatricyclo[5.3.0.0^{2,6}]decane-3,5,8,10-tetrone is added to a solution of 1.586 g (3.00 mmol) of [4-[(E)-3-[2-(2,4-diaminophenyl)ethoxy]-3-oxo-prop-1-enyl]phenyl]4-(4,4,4-trifluorobutoxy)benzoate, in 5.073 g of NMP. Stirring is then carried out at 0° C. for 2 hours. The mixture is subsequently allowed to react for 72 hours at room temperature. Polyamic acid P33 is obtained as 30 wt % NMP-solution with an inherent viscosity [η] of 0.54 dL/g.

### Example 72: Preparation of Formulation 27

To a solution of 2.125 g of Polyamic acid PX1 and 0.250 g of Polyamic acid P15 are added 2.875 g of NMP and 4.751 g of BC. The mixture is stirred for 30 minutes and filtrated on 0.2 μm PTFE-filter to give Formulation 27.

### Example 73: Preparation of Formulation 28

To a solution of 2.125 g of Polyamic acid PX1 and 0.250 g of Polyamic acid P16 are added 2.875 g of NMP and 4.751 g of BC. The mixture is stirred for 30 minutes and filtrated on 0.2 μm PTFE-filter to give Formulation 28.

### Example 74: Preparation of Formulation 29

To a solution of 2.125 g of Polyamic acid PX1 and 0.250 g of Polyamic acid P17 are added 2.875 g of NMP and 4.751 g of BC. The mixture is stirred for 30 minutes and filtrated on 0.2 μm PTFE-filter to give Formulation 29.

### Example 75: Preparation of Formulation 30

To a solution of 2.125 g of Polyamic acid PX1 and 0.250 g of Polyamic acid P18 are added 2.875 g of NMP and 4.751 g of BC. The mixture is stirred for 30 minutes and filtrated on 0.2 μm PTFE-filter to give Formulation 30.

### Example 76: Preparation of Formulation 31

To a solution of 2.125 g of Polyamic acid PX1 and 0.250 g of Polyamic acid P19 are added 2.875 g of NMP and 4.751 g of BC. The mixture is stirred for 30 minutes and filtrated on 0.2 μm PTFE-filter to give Formulation 31.

### Example 77: Preparation of Formulation 32

To a solution of 2.125 g of Polyamic acid PX1 and 0.250 g of Polyamic acid P20 are added 2.875 g of NMP and 4.751 g of BC. The mixture is stirred for 30 minutes and filtrated on 0.2 μm PTFE-filter to give Formulation 32.

### Example 78: Preparation of Formulation 33

To a solution of 2.125 g of Polyamic acid PX1 and 0.250 g of Polyamic acid P21 are added 2.875 g of NMP and 4.751 g of BC. The mixture is stirred for 30 minutes and filtrated on 0.2 μm PTFE-filter to give Formulation 33.

### Example 79: Preparation of Formulation 34

To a solution of 2.125 g of Polyamic acid PX1 and 0.250 g of Polyamic acid P22 are added 2.875 g of NMP and 4.751 g of BC. The mixture is stirred for 30 minutes and filtrated on 0.2 μm PTFE-filter to give Formulation 34.

### Example 80: Preparation of Formulation 35

To a solution of 2.125 g of Polyamic acid PX1 and 0.250 g of Polyamic acid P23 are added 2.875 g of NMP and 4.751 g of BC. The mixture is stirred for 30 minutes and filtrated on 0.2 μm PTFE-filter to give Formulation 35.

### Example 81: Preparation of Formulation 36

To a solution of 2.125 g of Polyamic acid PX1 and 0.250 g of Polyamic acid P24 are added 2.875 g of NMP and 4.751 g of BC. The mixture is stirred for 30 minutes and filtrated on 0.2 μm PTFE-filter to give Formulation 36.

### Example 82: Preparation of Formulation 37

To a solution of 2.125 g of Polyamic acid PX1 and 0.250 g of Polyamic acid P25 are added 2.875 g of NMP and 4.751 g of BC. The mixture is stirred for 30 minutes and filtrated on 0.2 μm PTFE-filter to give Formulation 37.

### Example 83: Preparation of Formulation 38

To a solution of 2.125 g of Polyamic acid PX1 and 0.250 g of Polyamic acid P26 are added 2.875 g of NMP and 4.751 g of BC. The mixture is stirred for 30 minutes and filtrated on 0.2 μm PTFE-filter to give Formulation 38.

### Example 84: Preparation of Formulation 39

To a solution of 2.125 g of Polyamic acid PX1 and 0.250 g of Polyamic acid P27 are added 2.875 g of NMP and 4.751 g of BC. The mixture is stirred for 30 minutes and filtrated on 0.2 μm PTFE-filter to give Formulation 39.

### Example 85: Preparation of Formulation 40

To a solution of 2.125 g of Polyamic acid PX1 and 0.250 g of Polyamic acid P28 are added 2.875 g of NMP and 4.751 g of BC. The mixture is stirred for 30 minutes and filtrated on 0.2 μm PTFE-filter to give Formulation 40.

### Example 86: Preparation of Formulation 41

To a solution of 2.125 g of Polyamic acid PX1 and 0.250 g of Polyamic acid P29 are added 2.875 g of NMP and 4.751 g of BC. The mixture is stirred for 30 minutes and filtrated on 0.2 μm PTFE-filter to give Formulation 41.

### Example 87: Preparation of Formulation 42

To a solution of 2.125 g of Polyamic acid PX1 and 0.250 g of Polyamic acid P30 are added 2.875 g of NMP and 4.751 g of BC. The mixture is stirred for 30 minutes and filtrated on 0.2 μm PTFE-filter to give Formulation 42.

### Example 88: Preparation of Formulation 43

To a solution of 2.125 g of Polyamic acid PX1 and 0.250 g of Polyamic acid P31 are added 2.875 g of NMP and 4.751 g of BC. The mixture is stirred for 30 minutes and filtrated on 0.2 μm PTFE-filter to give Formulation 43.

### Example 89: Preparation of Formulation 44

To a solution of 2.125 g of Polyamic acid PX1 and 0.250 g of Polyamic acid P32 are added 2.875 g of NMP and 4.751 g of BC. The mixture is stirred for 30 minutes and filtrated on 0.2 μm PTFE-filter to give Formulation 44.

### Example 90: Preparation of Formulation 45

To a solution of 2.125 g of Polyamic acid PX1 and 0.250 g of Polyamic acid P33 are added 2.875 g of NMP and 4.751 g of BC. The mixture is stirred for 30 minutes and filtrated on 0.2 μm PTFE-filter to give Formulation 45.

### Application Examples Part 2

### Example 29

Formulation 27 is spin-coated onto two ITO coated glass substrates at a spin speed of c.a. 2000 rpm for 30 seconds. After spin-coating, the substrates are subjected to a baking procedure consisting of pre-baking for 90 seconds at 80° C. and post-baking for 40 minutes at 200° C. Then, the substrates are exposed to linearly polarized light at an incidence angle of 40° relative to the normal of the substrate surface (22 mJ·cm²-LPUVB). The plane of polarization is parallel to the substrate's longest edges. The cells are assembled with the 2 substrates, the exposed polymer layers facing the inside of the cell. The substrates are adjusted relative to each other such that the induced alignment directions are parallel to each other. The cells are capillary filled with liquid crystal MLC-6610 (Merck KGA-Δε<0). Finally, the filled cells are further subjected to a thermal annealing at 130° C. for 10 minutes, thereby completing the cell process. The liquid crystal in the cell showed well defined and homogeneous vertical orientation before and after thermal annealing of the cell. A tilt angle of 88.27 is measured using the rotating analyser method from Shintech.

### Example 30

A cell is prepared as in Example 29, except that formulation 28 is coated. The liquid crystal in the cell showed well defined and homogeneous vertical orientation before and after thermal annealing of the cell. A tilt angle of 88.04 is measured using the rotating analyser method from Shintech.

### Example 31

A cell is prepared as in Example 29, except that formulation 29 is coated. The liquid crystal in the cell showed well defined and homogeneous vertical orientation before and after thermal annealing of the cell. A tilt angle of 88.17 is measured using the rotating analyser method from Shintech.

### Example 32

A cell is prepared as in Example 29, except that formulation 30 is coated. The liquid crystal in the cell showed well defined and homogeneous vertical orientation before and after thermal annealing of the cell. A tilt angle of 88.14 is measured using the rotating analyser method from Shintech.

### Example 33

A cell is prepared as in Example 29, except that formulation 31 is coated. The liquid crystal in the cell showed well defined and homogeneous vertical orientation before and after thermal annealing of the cell. A tilt angle of 88.21 is measured using the rotating analyser method from Shintech.

### Example 34

A cell is prepared as in Example 29, except that formulation 32 is coated. The liquid crystal in the cell showed well defined and homogeneous vertical orientation before and after thermal annealing of the cell. A tilt angle of 88.16 is measured using the rotating analyser method from Shintech.

### Example 35

A cell is prepared as in Example 29, except that formulation 33 is coated. The liquid crystal in the cell showed well defined and homogeneous vertical orientation before and after thermal annealing of the cell. A tilt angle of 87.97 is measured using the rotating analyser method from Shintech.

### Example 36

A cell is prepared as in Example 29, except that formulation 34 is coated. The liquid crystal in the cell showed well defined and homogeneous vertical orientation before and after thermal annealing of the cell. A tilt angle of 87.17 is measured using the rotating analyser method from Shintech.

### Example 37

A cell is prepared as in Example 29, except that formulation 35 is coated. The liquid crystal in the cell showed well defined and homogeneous vertical orientation before and after thermal annealing of the cell. A tilt angle of 87.01 is measured using the rotating analyser method from Shintech.

### Example 38

A cell is prepared as in Example 29, except that formulation 36 is coated. The liquid crystal in the cell showed well defined and homogeneous vertical orientation before and after thermal annealing of the cell. A tilt angle of 87.23 is measured using the rotating analyser method from Shintech.

### Example 39

A cell is prepared as in Example 29, except that formulation 37 is coated. The liquid crystal in the cell showed well defined and homogeneous vertical orientation before and after thermal annealing of the cell. A tilt angle of 87.38 is measured using the rotating analyser method from Shintech.

### Example 40

A cell is prepared as in Example 29, except that formulation 38 is coated. The liquid crystal in the cell showed well defined and homogeneous vertical orientation before and after thermal annealing of the cell. A tilt angle of 87.04 is measured using the rotating analyser method from Shintech.

### Example 41

A cell is prepared as in Example 29, except that formulation 39 is coated. The liquid crystal in the cell showed well defined and homogeneous vertical orientation before and after thermal annealing of the cell. A tilt angle of 86.67 is measured using the rotating analyser method from Shintech.

### Example 42

A cell is prepared as in Example 29, except that formulation 40 is coated. The liquid crystal in the cell showed well defined and homogeneous vertical orientation before and after thermal annealing of the cell. A tilt angle of 88.64 is measured using the rotating analyser method from Shintech.

### Example 43

A cell is prepared as in Example 29, except that formulation 41 is coated. The liquid crystal in the cell showed well defined and homogeneous vertical orientation before and after thermal annealing of the cell. A tilt angle of 88.18 is measured using the rotating analyser method from Shintech.

### Comparative Example 44

A cell is prepared as in Example 29, except that formulation 42 is coated. The liquid crystal in the cell showed well defined and homogeneous vertical orientation before and after thermal annealing of the cell. A tilt angle of 88.27 is measured using the rotating analyser method from Shintech.

### Comparative Example 45

A cell is prepared as in Example 29, except that formulation 43 is coated. The liquid crystal in the cell showed well defined and homogeneous vertical orientation before and after thermal annealing of the cell. A tilt angle of 87.89 is measured using the rotating analyser method from Shintech.

### Comparative Example 46

A cell is prepared as in Example 29, except that formulation 44 is coated. The liquid crystal in the cell showed well defined and homogeneous vertical orientation before and after thermal annealing of the cell. A tilt angle of 88.29 is measured using the rotating analyser method from Shintech.

### Comparative Example 47

A cell is prepared as in Example 29, except that formulation 45 is coated. The liquid crystal in the cell showed well defined and homogeneous vertical orientation before and after thermal annealing of the cell. A tilt angle of 86.66 is measured using the rotating analyser method from Shintech.

### Example 48

Voltage holding ratio (VHR) of the cells is measured at 60° C. using LCM-1 instrument from Toyo, Japan. The VHR was measured using a short and a long frame period (T). In the short one, the voltage decay V (at T=16.67 ms) of a voltage surge of 64 μs with V₀(V at t=0)=1V is then measured over a period of T=16.67 ms. The voltage holding ratio is then determined, at room temperature, given by integration of the measurement curve between V₀ and V weighted by the area in the case of 100% VHR. The table below shows VHR measured for all tested cells. The results show VHR >99% for all tested cells except the comparative examples 44, 45 and 46 which led to poor electrical property.

| Cell | Alignment quality | VHR |
|---|---|---|
| Example 29 | Good | 99.7% |
| Example 30 | Good | 99.7% |
| Example 31 | Good | 99.8% |
| Example 32 | Good | 99.7% |
| Example 33 | Good | 99.8% |
| Example 34 | Good | 99.7% |
| Example 35 | Good | 99.7% |
| Example 36 | Good | 99.6% |
| Example 37 | Good | 99.7% |
| Example 40 | Good | 99.6% |
| Example 41 | Good | 99.7% |
| Example 42 | Good | 99.7% |
| Example 43 | Good | 99.6% |
| Comparative example 44 | Good | 96.0% |
| Comparative example 45 | Good | 85.1% |
| Comparative example 46 | Good | 89.6% |
| Comparative example 47 | Good | 99.4% |

### Example 49: determination of AC memory (ACM)

An AC-voltage of 60 Hz frequency and 7.5 V amplitude is applied to cells prepared examples 1 to 25. After 48 hours of stress, the cells are short-circuited, and the change of the pre-tilt angle is measured after 60 min of relaxation. The difference in pretilt measurement between before and after the stress-relaxation cycle gives AC-Memory (ACM°). If ACM° is excellent below −0.015°, very good between −0.016° and −0.030°, good between −0.031° and −0.045°, medium between −0.046° and −0.060° and bad for value higher than −0.061°.

| Cell | Tilt angle | ACM [°] |
|---|---|---|
| Example 29 | 88.27 | excellent |
| Example 30 | 88.04 | excellent |
| Example 31 | 88.17 | very good |
| Example 32 | 88.14 | very good |
| Example 33 | 88.21 | very good |
| Example 34 | 88.16 | very good |
| Example 35 | 87.97 | good |
| Example 36 | 87.17 | excellent |
| Example 37 | 87.01 | good |
| Example 38 | 87.23 | good |
| Example 39 | 87.38 | very good |
| Example 40 | 87.04 | good |
| Example 41 | 86.67 | good |
| Example 42 | 88.64 | excellent |
| Example 43 | 88.18 | excellent |
| Comparative example 47 | 86.66 | bad |

1. A compound of formula (I) 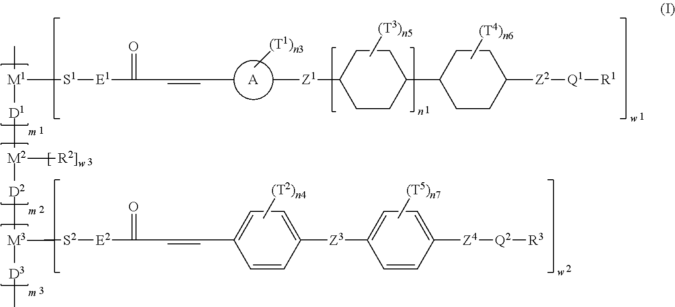
wherein,
M¹, M² and M³ represent independently from each other an unsubstituted or substituted carbocyclic or heterocyclic aromatic or non-aromatic diamine group selected from a monocyclic ring of five or six atoms; two adjacent monocyclic rings of five or six atoms, a bicyclic ring system of eight, nine or ten atoms, a tricyclic ring system of thirteen or fourteen atoms, and mono-, bi-, tricyclic rings, which are linked by a straight-chain or branched, substituted or unsubstituted
C₁-C₂₀alkanediyl, which is unsubstituted or substituted by di-(C₁-C₂₀alkyl)amino, C₁-C₆alkyloxy, nitro, cyano and/or chlorine or fluorine; and wherein one or more C—, CH—, CH₂— group may independently be replaced by a linking group;
D¹, D² and D³ represent independently from each other an unsubstituted or substituted aliphatic, alicyclic group or carbocyclic or heterocyclic aromatic group substituted with at least two carboxylic acid groups, or activated carboxylic groups, or anhydride groups;
m¹, m² or m³ represent independently from each other molar fractions of the comonomers with 0<m¹<1, 0≤m²≤0, 7 and 0≤m³<1;
S¹ and S² represent independently from each other a spacer unit,
E¹ and E² represent independently from each other an aromatic group, an oxygen atom, a sulphur atom, —NH—, —N(C₁-C₆alkyl)-, —CR⁴R⁵, wherein R⁴ and R⁵ are independently from each other hydrogen or a cyclic, straight-chain or branched, substituted or unsubstituted C₁-C₃₀alkyl, wherein one or more C—, CH—, CH₂— group may be independently from each other replaced by a linking group, and with the proviso that at least one of R⁴ and R⁵ is not hydrogen;
A represents an unsubstituted or substituted carbocyclic or heterocyclic aromatic group,
Z¹, Z², Z³ and Z⁴ represent independently from each other a bridging group,
Q¹ and Q² represent independently from each other a single bond, or a straight-chain or branched, substituted or unsubstituted C₁-C₂₀alkanediyl which is unsubstituted or substituted by di-(C₁-C₂₀alkyl)amino, C₁-C₆alkyloxy, nitro, cyano and/or chlorine or fluorine; and wherein one or more C—, CH—, CH₂— group may independently be replaced by a linking group;
R² represents hydrogen or a straight-chain or branched C₁-C₂₀alky, which is unsubstituted or substituted by di-(C₁-C₂₀alkyl)amino, C₁-C₆alkyloxy, nitro, cyano and/or chlorine or fluorine; and wherein one or more C—, CH—, CH₂— group may independently be replaced by a linking group;
R¹ and R³ represent independently from each other hydrogen or C_{c}H_{α}F_{β}, wherein c is an integer of 0 to 20, and α and β are integers of 0 to 2 c+1, respectively, wherein α+β=2 c+1;
T¹, T², T³, T⁴ and T⁵ represent independently from each other hydrogen, halogen, hydroxyl, nitro, cyano or a carboxy group, and/or a cyclic, straight-chain or branched C₁-C₃₀alkyl, which is unsubstituted, mono- or poly-substituted with halogen, acryloyloxy, alkylacryloyloxy, alkoxy, alkylcarbonyloxy, alkyloxycarbonyl-oxy, alkyloxocarbonyloxy, vinyl, vinyloxy and/or allyloxy group;
n¹ is 0, 1 or 2,
n³, n⁴, n⁵, n^{b} and n⁷ represent independently from each other 0, 1, 2 or 3;
w³ represents 0, 1, 2, 3 or 4;
w¹ and w² represent independently from each other is 1, 2, 3 or 4,
with the proviso that if w¹ or w² is 2, 3, or 4, each S¹ and S², E¹ and E², Z¹, Z², Z³ and Z⁴, Q¹ and Q², R², R¹ and R³, T¹, T², T³, T⁴ and T⁵, n¹, n³, n⁴, n⁵, n⁶ and n⁷ may be identical or different.

2. A compound according to claim 1, wherein A is a substituted or unsubstituted phenylene, naphthalene, biphenylene or triphenylene ring.

3. A compound according to claim 1, wherein m¹, m² or m³ represent independently from each other molar fractions of the comonomers
0<m<1, 0≤m²≤0.5 and 0≤m³<1.

4. A compound according to claim 1, wherein R²
represents hydrogen, straight-chain or branched C₁-C₆alkyl; or a straight-chain or branched
C₁-C₁₆fluoralkyl group.

5. A composition comprising at least one compound of formula (I) as described in claim 1.

6. A method for the preparation of a compound (I) as described in claim 1 comprising polymerising of at least one diamine M¹, M² or M³ with at least one D¹, D² and D3, which represent independently from each other an unsubstituted or substituted aliphatic, alicyclic group or carbocyclic or heterocyclic aromatic group substituted with at least two carboxylic acid groups, or activated carboxylic groups, or anhydride groups.

7. A compound (I), or a composition, as described in claim 1.

8. A polymer, copolymer or oligomer layer comprising a compound of formula (I) as described in claim 1.

9. A method comprising using a compound according to claim 1, in the manufacture of an optical or an electro-optical device.

10. An optical or electro-optical device including a compound according to claim 1.

11. A compound according to claim 2, wherein m¹, m² or m³ represent independently from each other molar fractions of the comonomers 0<m<1, 0≤m²≤0.5 and 0≤m³<1.

12. A compound according to claim 2, wherein R²
represents hydrogen, straight-chain or branched C₁-C₆alkyl; or a straight-chain or branched
C₁-C₁₆fluoralkyl group.

13. A composition comprising at least one compound of formula (I) as described in claim 2.

14. A compound (I), or a composition, obtainable according to the method as described in-claim 6.

15. A polymer, copolymer or oligomer layer comprising a compound of formula (I) as described in claim 2.

16. A method comprising using a composition according to claim 6, in the manufacture of an optical or an electro-optical device.

17. An optical or electro-optical device including a compound according to claim 5.

18. An optical or electro-optical device including a polymer, copolymer or oligomer layer according to claim 8.
